(19) United States
(12) Patent Application Publication
(10) Pub. No.: US 2005/0192629 A1
(43) Pub. Date: Sep. 1, 2005

(54) Methods and apparatus for creating and regulating a gastric stoma

(75) Inventors: Vahid Saadat, Saratoga, CA (US); Richard C. Ewers, Fullerton, CA (US); Rodney Brenneman, San Juan Capistrano, CA (US); Tracy D. Maahs, Rancho Santa Margarita, CA (US); Lee L. Swanstrom, Portland, OR (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: USGI Medical Inc., San Clemente, CA (US)

(21) Appl. No.: 11/058,739

(22) Filed: Feb. 14, 2005

Related U.S. Application Data
(63) Continuation-in-part of application No. 10/288,619, filed on Nov. 4, 2002.
Application No. 10/288,619 is a continuation-in-part of application No. 09/746,579, filed on Dec. 20, 2000.
Application No. 10/288,619 is a continuation-in-part of application No. 10/188,509, filed on Jul. 3, 2002.
Application No. 10/188,509 is a continuation-in-part of application No. 09/898,726, filed on Jul. 3, 2001, now Pat. No. 6,626,899.
Application No. 09/898,726 is a continuation-in-part of application No. 09/602,436, filed on Jun. 23, 2000, now Pat. No. 6,669,687.
(60) Provisional application No. 60/545,403, filed on Feb. 17, 2004.
(60) Provisional application No. 60/141,077, filed on Jun. 25, 1999.

(51) Int. Cl. A61D 1/00

(52) U.S. Cl. 606/221

(57) ABSTRACT

Apparatus and methods are provided for creating and regulating a gastric stoma by intraluminally reducing or partitioning a local cross-sectional area of the stomach, thereby inducing weight loss in obese patients. Various embodiments of stomas in accordance with the present invention are provided, as well as various regulation mechanisms for controlling or adjusting the size of the stoma.

### CROSS-REFERENCES TO RELATED APPLICATIONS

This application claims the benefits of priority to U.S. provisional patent application Ser. No. 60/545,403, filed Feb. 17, 2004, and is a continuation-in-part of U.S. patent application Ser. No. 10/288,619, filed Nov. 4, 2002, which is a continuation-in-part of U.S. patent application Ser. No. 09/746,579, filed Dec. 20, 2000, and a continuation-in-part of co-pending, commonly assigned U.S. patent application Ser. No. 10/188,509, filed Jul. 3, 2002, which is a continuation-in-part of U.S. patent application Ser. No. 09/898,726, filed Jul. 3, 2001, which is a continuation-in-part of U.S. patent application Ser. No. 09/602,436, filed Jun. 23, 2000, which claims benefit from U.S. provisional patent application Ser. No. 60/141,077, filed Jun. 25, 1999, the entireties of which are incorporated herein by reference.

### BACKGROUND OF THE INVENTION

Field of the Invention

The present invention relates to apparatus and methods for creating and regulating a stoma within a patient's gastrointestinal (“GI”) lumen. More particularly, the present invention relates to apparatus and methods for creating and regulating a gastric stoma by intraluminally reducing or partitioning a local cross-sectional area of the stomach, thereby inducing weight loss in obese patients.

Extreme or morbid obesity is a serious medical condition pervasive in the United States and other countries. Its complications include hypertension, diabetes, coronary artery disease, stroke, congestive heart failure, multiple orthopedic problems and pulmonary insufficiency with markedly decreased life expectancy.

Several surgical techniques have been developed to treat morbid obesity, e.g., bypassing an absorptive surface of the small intestine, or reducing the stomach size. These procedures are difficult to perform in morbidly obese patients and present numerous life-threatening post-operative complications.

U.S. Pat. Nos. 4,416,267 and 4,485,805 to Garren et al. and Foster, Jr., respectively, propose disposal of an inflated bag within a patient's stomach to decrease the effective volume of the stomach that is available to store food. Accordingly, the patient is satiated without having to consume a large amount of food. A common problem with these inflated bags is that, since the bags float freely within the patient's stomach, the bags may migrate to and block a patient's pyloric opening, the portal leading from the stomach to the duodenum, thereby restricting passage of food to the remainder of the gastro-intestinal tract.

Apparatus and methods also are known in which an adjustable elongated gastric band is disposed around the outside of a patient's stomach near the esophagus to form a collar that, when tightened, squeezes the stomach into an hourglass shape, thereby providing a stoma that limits the amount of food that a patient comfortably may consume. An example of an adjustable gastric band is the LAP-BAND® made by INAMED Health of Santa Barbara, Calif.

Numerous disadvantages are associated with using the adjustable gastric band. First, the band may be dislodged if the patient grossly overeats, thereby requiring additional invasive surgery to either reposition or remove the band. Similarly, overeating may cause the band to injure the stomach wall if the stomach over-expands. The laparoscopic disposal of the gastric band around the stomach requires a complex procedure, requires considerable skill on the part of the clinician, and is not free of dangerous complications. To dispose the gastric band around a patient's stomach, a clinician must perform a surgical procedure to gain access to the patient's stomach from outside the stomach. This is typically performed using the narrow field of vision provided by a conventional laparoscope, and presents a risk that the clinician inadvertently may perforate the stomach, damage major organs and vessels disposed in the vicinity of the stomach, such as the liver, kidneys, and the abdominal aorta, damage the vagus nerve and/or cause numerous other complications associated with surgery.

In view of the foregoing, it would be desirable to provide apparatus and methods for creating and regulating a gastric stoma via intraluminal reduction of a local cross-sectional area of the stomach.

### BRIEF SUMMARY OF THE INVENTION

Apparatus and methods for creating and regulating a gastric stoma may be provided for intraluminally reducing or partitioning a local cross-sectional area of the stomach. The gastric stoma described may also reduce the risk of damaging surrounding organs, vessels, and nerves when compared to conventional devices and methods. The localized reduction or partition redefines the gastrointestinal (“GI”) lumen into first and second portions. The reduced volume of the first portion, as compared to the native volume of the GI lumen, constrains an amount of food that a patient consumes by providing a feeling of satiety after only a small amount of food has been consumed. Furthermore, the reduced cross-sectional area of the GI lumen reduces a rate at which food passes through the GI lumen. This increases a residence time of the food within the first portion of the GI lumen, thereby enhancing the feeling of satiety.

In a preferred embodiment, apparatus of the present invention includes a stoma that may be endoscopically implanted within a patient. In an even more preferred embodiment, a cross-sectional area of the stomal lumen(s) may be adjusted non- or minimally invasively to regulate food passage through the stoma. For example, the stoma may be endoscopically adjusted within the patient intra- or post-operatively. The stoma may also be configured to dynamically adjust itself in response to pressure sensed from ingested food proximal to the apparatus. Implantable stomas in accordance with the present invention optionally may be used in conjunction with complementary gastric reductive or constrictive apparatus and methods, per se known.

The implantable stoma may comprise one or more anchoring elements configured to intraluminally secure the stoma to a wall of the GI lumen to prevent dislodgement or migration of the apparatus. Alternatively, the stoma may be disposed submucosally to achieve anchoring. Contrivance may be provided for adjusting/regulating a cross-sectional area of the stomal lumen, for example, a drawstring; an inflatable member; a resilient element, such as a ring, mesh, braid, stent, or stent graft; a fluid reservoir; bulking agents; an iris; radiofrequency elements; etc. Adjustment of the stoma may, for example, be performed endoscopically, e.g. via an endoscopically retrievable tube or via an endoscopically accessible port; through actuation, e.g. remote actuation via an external control unit, of implanted elements coupled to the adjustment contrivance; via a subcutaneously implanted port; dynamically in response to the pressure of food in the GI lumen; etc. Also provided are delivery catheters for delivering and deploying the stoma without injuring surrounding organs and vessels.

Methods of using the apparatus of the present invention also are provided.

### BRIEF DESCRIPTION OF THE DRAWINGS

Further features of the present invention, its nature and various advantages will be more apparent from the accompanying drawings and the following detailed description of the preferred embodiments, in which:

FIG. 1 is a schematic perspective view of a stoma comprising a plurality of anchors coupled to a partition of the present invention;

FIG. 2 is a schematic perspective view of one of the plurality of anchors of FIG. 1;

FIG. 3 is a schematic close-up view of an alternative embodiment of one of the plurality of anchors;

FIG. 4 are schematic views of alternative embodiments of the plurality of anchors of the present invention;

FIG. 5 is a schematic perspective view of a fastener for maintaining tension applied to the partition of FIG. 1;

FIG. 6 is a schematic perspective view of an alternative embodiment of a fastener for maintaining tension applied to the partition of FIG. 1;

FIG. 7 are perspective side sectional and frontal views of a guide catheter that accepts an endoscope and a delivery catheter for delivering the apparatus of the present invention;

FIGS. 8A-8E are schematic side views depicting a method of using the apparatus of the present invention;

FIG. 9 is a schematic side view of an alternative delivery catheter for delivering the plurality of anchors of FIG. 1;

FIG. 10 is a schematic perspective view of an alternative embodiment of the plurality of anchors of the present invention coupled to the partition of FIG. 1;

FIGS. 11A-11D are schematic side views of further alternative embodiments of the plurality of anchors of the present invention;

FIGS. 12A and 12B are, respectively, schematic cross-sectional and side views of a delivery catheter for delivering the plurality of anchors of FIGS. 10 and 11A—11D;

FIG. 13 is a schematic perspective view of yet another alternative embodiment of the plurality of anchors of the present invention;

FIGS. 14A-14C are schematic side views of multiple embodiments of the plurality of anchors of FIG. 13;

FIG. 15 is a schematic cross-sectional view of a delivery catheter for delivering the plurality of anchors of FIGS. 14A-14C;

FIG. 16 is a schematic perspective view of still another alternative embodiment of the plurality of anchors of the present invention coupled to the partition of FIG. 1;

FIG. 17 is a schematic perspective view of the partition of the preceding FIGS. operably coupled to a motor for adjustment of the cross-sectional area defined by the partition;

FIG. 18 is a schematic perspective view of an alternative stoma partition of the present invention;

FIG. 19 is a schematic cross-sectional view of the partition of FIG. 18;

FIG. 20 is a schematic cross-sectional view of two of the plurality of anchors of FIG. 10 coupled to the partition of FIG. 18;

FIGS. 21A and 21B are, respectively, a schematic cross-sectional view of one of the plurality of anchors of FIG. 10 coupled to the partition of FIG. 18 via a latch, and a schematic side view of the latch;

FIG. 22 is a schematic cross-sectional view of an alternative embodiment of the partition of FIG. 18;

FIG. 23 is a schematic perspective view of a pump and a reservoir for inflation of the partition of FIG. 18;

FIG. 24 is a schematic cross-sectional perspective view of an alternative embodiment of the stoma partition of FIG. 18, in which a cross-sectional area of a stoma defined by the partition is adjusted through actuation of a worm gear assembly;

FIG. 25 is a schematic cross-sectional perspective view of another alternative embodiment of the partition of FIG. 18, in which a cross-sectional area of a stoma defined by the partition is adjusted by ohmically heating a thermally-responsive shape memory alloy;

FIG. 26A is a schematic cross-sectional view of yet another alternative embodiment of the partition of FIG. 18, in which a cross-sectional area of a stoma defined by the partition may be adjusted by inductively heating a thermally-responsive shape memory alloy;

FIG. 26B is a schematic cross-sectional view of a toroidal inductor of FIG. 26A disposed surrounding the thermally-responsive shape memory alloy;

FIG. 27 is a graph of an illustrative relationship between the pressure within the partition of FIG. 18 and a diameter of a stoma defined by the partition;

FIG. 28 is a schematic top view of a plurality of ultrasound transducers disposed around a stoma defined by the partition of FIG. 18, the plurality of ultrasound transducers configured to facilitate measurement of a stoma diameter;

FIG. 29 is a schematic top view of a conductive band disposed around a stoma defined by the partition of FIG. 18, the conductive band having a length-dependent resistance to facilitate measurement of a stoma diameter;

FIGS. 30A and 30B are schematic cross-sectional views of alternative cross-sectional shapes of the partition of FIG. 18;

FIG. 31 is a schematic cross-sectional side view of a cuff configured for disposal proximal to the partition of FIG. 30B, and to direct food through a stoma defined thereby;

FIGS. 32A and 32B are cross-sectional views of still another alternative embodiment of the partition of FIG. 18 that enhances sealing engagement between the partition and a wall of a GI lumen;

FIG. 33 is a side view, partially in section illustrating methods and apparatus for forming and regulating a stoma at the outlet of a Vertical Banded Gastroplasty pouch via bulking agents;

FIG. 34 is an isometric view of an alternative stoma in accordance with the present invention comprising a sewing ring;

FIG. 35 is an isometric view of a sieve stoma of the present invention;

FIG. 36 is a side view, partially in section, of a reinforced suture stoma;

FIG. 37 is an isometric view of an adjustable iris stoma;

FIG. 38 is an isometric view of a nested ring stoma;

FIG. 39 is a side view, partially in section, illustrating methods and apparatus for forming and regulating a stoma via tissue scarring;

FIGS. 40A-40C are, respectively, a side view of a restrictive band placed about the exterior of the stomach from the interior of the stomach, a schematic view of apparatus for performing such a procedure, and a side view, partially in section, illustrating a method of performing the procedure utilizing said apparatus;

FIG. 41 is a schematic view of a wireless system for regulating a stoma formed at the outlet of a Vertical Banded Gastroplasty pouch;

FIG. 42 is a more detailed illustrative schematic view of an embodiment of the apparatus of FIG. 41;

FIG. 43 is a schematic view of a fluid-based alternative embodiment of the apparatus of FIG. 41;

FIG. 44 is a schematic view of an alternative fluid-based embodiment of the apparatus of FIG. 41;

FIG. 45 is a schematic view of a viscoelastic stoma of the present invention;

FIG. 46 is a schematic view of an Electroactive Polymer stoma of the present invention;

FIG. 47 is a schematic view of a dynamically adjustable stoma fabricated from foam;

FIGS. 48A-48D are side- and side-sectional detail views illustrating a method for forming a stoma with mesh strips disposed on the anterior and posterior of a patient's stomach;

FIG. 49A-49C are schematic side and sectional views of various tubular mesh stomas in accordance with the present invention; and

FIGS. 50A and 50B are schematic side views of an alternative embodiment of a dynamically adjustable mesh stoma that may be provided with a specified minimum diameter.

### DETAILED DESCRIPTION OF THE INVENTION

The present invention relates to apparatus and methods for creating and regulating a stoma within a patient's gastrointestinal (“GI”) lumen. More particularly, the present invention relates to apparatus and methods for creating and regulating a gastric stoma by intraluminally reducing or partitioning a local cross-sectional area of the stomach, thereby defining first and second portions of the lumen and inducing weight loss in obese patients. The reduced volume of the first portion, as compared to the native volume of the GI lumen, constrains an amount of food a patient consumes by providing a feeling of satiety after only a small amount of food is consumed. Furthermore, the reduced or partitioned cross-sectional area of the GI lumen reduces a rate at which food passes through the GI lumen. This increases residence time of the food within the first portion of the GI lumen, thereby enhancing the feeling of satiety. It will be obvious to one of skill in the art that, while the following written description illustratively describes use of the apparatus and methods of the present invention to partition or reduce a patient's stomach, the present invention may be implanted anywhere in the gastro-intestinal tract, e.g., esophagus, and within a variety of body lumens requiring restriction of flow of materials therethrough.

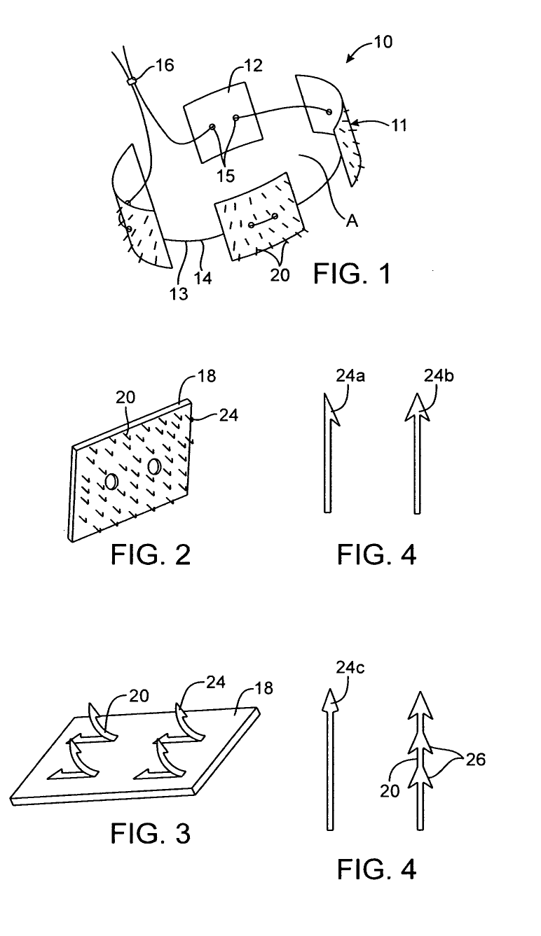

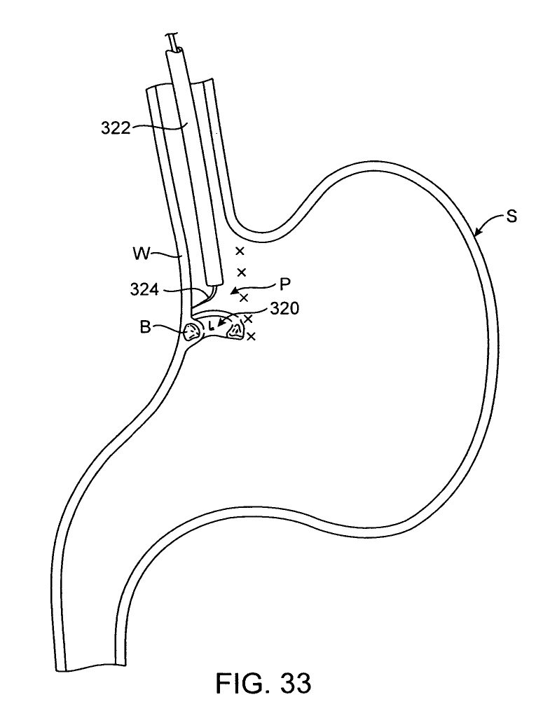

Referring to FIGS. 1 and 2, a first embodiment of apparatus of the present invention schematically is illustrated in a deployed configuration. Apparatus 10 comprises implantable stoma 11 having plurality of anchors 12 configured to penetrate into a wall of the GI lumen to prevent dislodgement or migration of the apparatus. Stoma 11 further comprises contrivance or partition 13 for adjusting/regulating a cross-sectional area of the stomal lumen. Contrivance 13 illustratively comprises drawstring 14, coupled to plurality of anchors 12 through fixture points 15, as well as fastener 16 that maintains tension applied to drawstring 14. When anchors 12 are engaged to the lumen wall and drawstring 14 is coupled to the anchors, apparatus 10 defines stoma 11 having cross-sectional area A that is substantially coincident with a local cross-sectional area of the GI lumen. Accordingly, when tension is applied to drawstring 14, each anchor 12 is drawn closer to adjacent anchors. Since anchors 12 are engaged to the lumen wall, this action cinches the GI lumen to form a partition that defines a localized reduction in the cross-sectional area of the GI lumen. Apparatus 10 also may be used as a complement to known bariatric procedures. For example, apparatus 10 may be used in conjunction with Vertical Banded Gastroplasty (“VBG”; see FIG. 33), in which case apparatus 10 would form stoma 11 of reduced cross-section at the outlet of the VBG pouch.

Each anchor 12 incorporates substrate 18 having multiplicity of barbs 20 and at least one fixture point 15, e.g., an eyelet, through which drawstring 14 may be threaded. Preferably, substrate 18 is made of a flexible material to permit the anchor to conform to the surface of the lumen wall. Each barb 20 has sharpened distal end 24 that enables the barb to penetrate into the lumen wall, and to resist disengagement therefrom when tensile forces applied to drawstring 14 are transmitted to anchor 12. Distal ends 24 of barbs 20 may have a harpoon configuration (24a in FIG. 4), an arrow configuration (24b in FIG. 4), or a conical configuration (24c in FIG. 4). Alternatively, barbs 20 may include additional ribs, hooks, or projections 26 disposed along shanks 28 of barbs 20 to further enhance the engagement of the barbs to the lumen wall.

FIG. 3 depicts a method of manufacturing anchor 12, wherein the barbs are integrally formed from substrate 18 comprising a thin, flexible sheet of biocompatible polymer or metal alloy. Barbs 20 are die cut from substrate 18, and then bent out of the plane of substrate 18 to expose sharpened distal ends 24. In a preferred embodiment, barbs 20 are bent at either an acute or an obtuse angle with respect to substrate 18 so that, when the angled barbs are engaged to the lumen wall in a downward radial direction, a distal force applied by food entering the GI lumen will less likely disengage the anchors. Accordingly, the biocompatible polymer or metal alloy preferably comprises a material that provides barbs 20 with sufficient rigidity to penetrate the lumen wall during application, and to withstand the tensile forces and moments expected during normal use, i.e., so barbs 20 cannot be pulled out of the lumen wall, and shanks 28 will not fracture in large numbers.

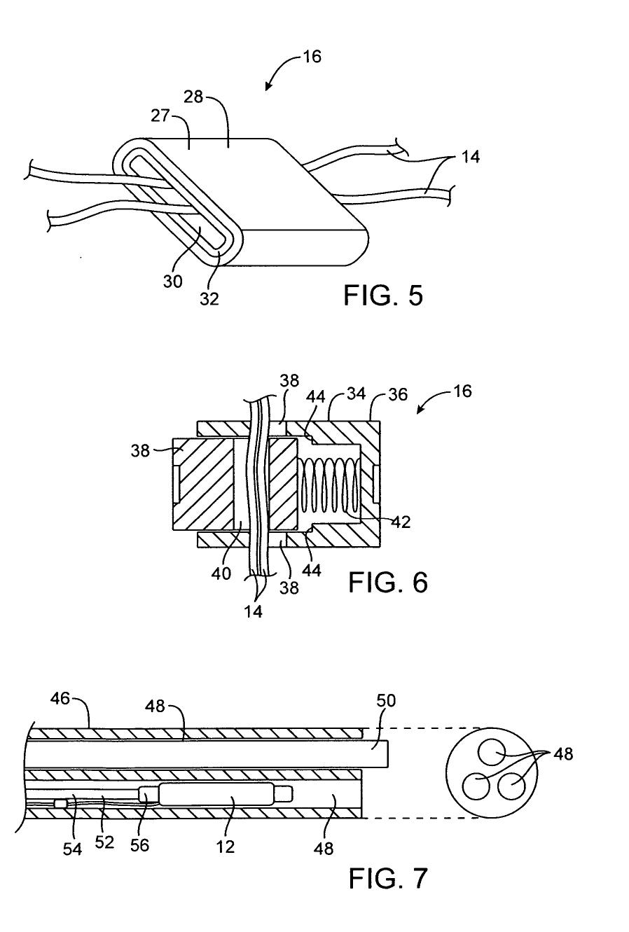

Referring now to FIG. 5, fastener 16 is described in detail. Fastener 16 includes collar 27 having body 28 and channel 30 through which drawstring 14 may freely translate prior to crimping. Once fastener 16 is crimped by a mallet/anvil assembly to be described in greater detail hereinbelow, drawstring 14 is restrained from freely translating through channel 30. This permits fastener 16 to maintain tension applied to drawstring 14, and thus the local reduction or partition in the cross-sectional area of the GI lumen. Optionally, to decrease the likelihood that tension applied to drawstring 14 may be inadvertently lost through slippage of the drawstring through channel 30, body 28 may incorporate lining 32 to further enhance uni-directional friction between body 28 and drawstring 14 to reduce the risk of slippage. Lining 32 may comprise a biocompatible, elastomeric material, and/or a lining having barbs or a roughened surface.

Alternatively, to enable cross-sectional area A defined by drawstring 14, and thus the localized reduction or partition in the cross-sectional area of the GI lumen, to be adjusted, fastener 16 may comprise adjustable clip 34 having housing 36 and engagement piece 38 translatably disposed within housing 36. Housing 36 includes first bore 38, which is disposed orthogonal to the direction of translation of engagement piece 38, and has a cross-sectional area that accommodates unrestricted movement of drawstring 14 therethrough. Likewise, engagement piece 38 also incorporates second bore 40 disposed parallel to first bore 38, and having a cross-sectional area that will accommodate unrestricted movement of drawstring 14 therethrough. Also included within clip 34 is spring 42 that is disposed between housing 36 and engagement piece 38 to bias engagement piece 38 so that first and second bores 38 and 40 are misaligned absent an external force to counter the force of spring 42. When the first and second bores are misaligned, drawstring 14 is constrained from freely translating therethrough. When an external force is applied to counter the outward biasing force of spring 42, engagement piece 38 translates within housing 36 until engagement piece 38 contacts ledge 44. At this point, first and second bores 38 and 40 are aligned, and drawstring 14 may move freely therethrough to adjust the tension applied to drawstring 14. Advantageously, this permits the reduction in the cross-sectional area of the GI lumen to be adjusted, thereby providing control over the rate that food passes through the GI lumen.

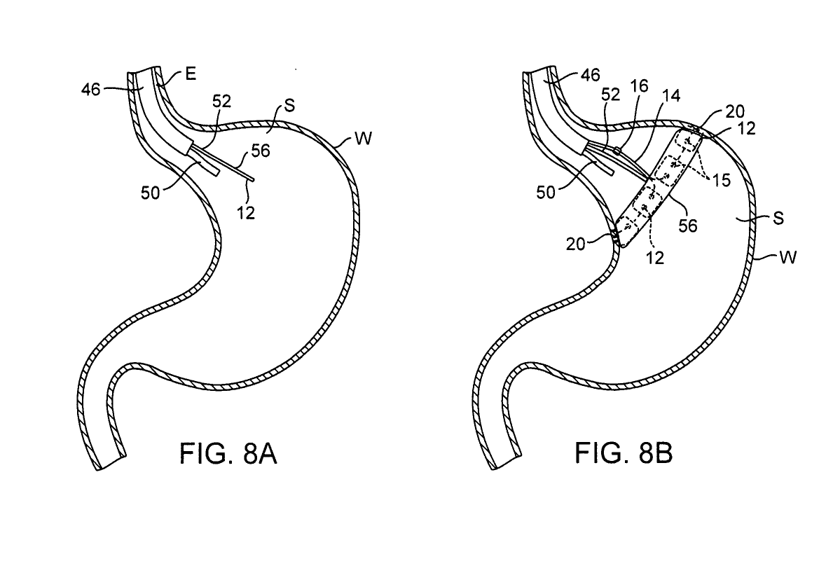

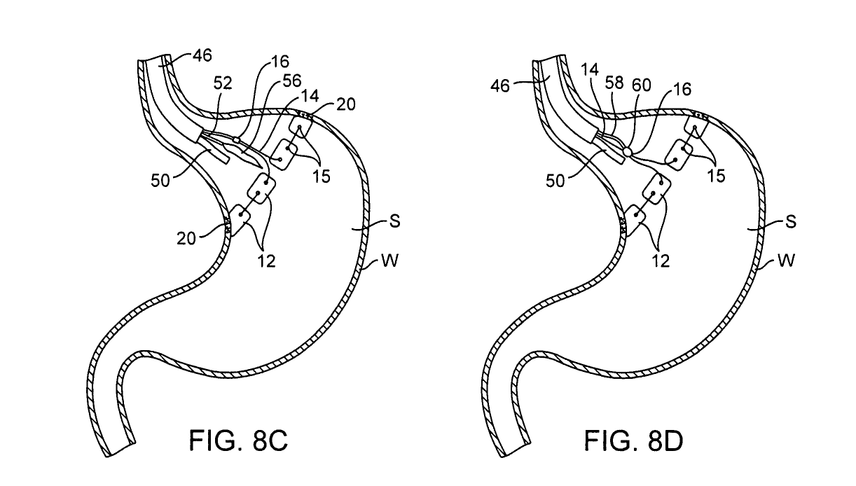

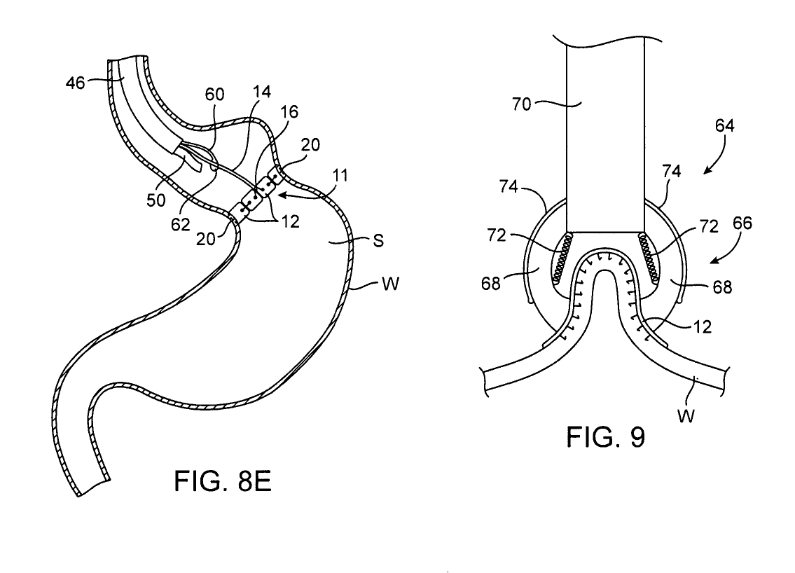

Referring now to FIG. 7, guide catheter 46 is described. To facilitate endoscopic delivery of apparatus 10 of the present invention, guide catheter 46 includes plurality of lumens 48 that accommodate advancement of endoscope 50, per se known in the art. Plurality of lumens 48 also accommodates advancement of delivery catheter 52 having lumen 54 coupled in fluid communication with inflatable member 56, which is disposed on the distal end of delivery catheter 52. As illustrated in greater detail in FIG. 8B, plurality of anchors 12 are removably attached to an external surface of inflatable member 56 by, e.g., a weak adhesive. In FIG. 7, plurality of anchors 12 are disposed on inflatable member 56 in their delivery configuration so that they may be advanced through lumen 48 of guide catheter 46.

Preferably, drawstring 14 is pre-threaded through fixture points 15 prior to adherence of anchors 12 to inflatable member 56. Drawstring 14 also preferably has sufficient length to span lumen 48 proximal to inflatable member 56 so that a clinician can grasp the ends of drawstring 14 (not shown) to facilitate delivery of apparatus 10 in a manner described in greater detail hereinbelow. Furthermore, fastener 16 preferably is engaged to drawstring 14 prior to advancement of delivery catheter 52 into lumen 48 to facilitate delivery of apparatus 10. It will be apparent to one of ordinary skill in the art that, while distal ends 24 of barbs 20 are sufficiently sharp to penetrate the lumen wall of the GI lumen, the distal ends also preferably are sufficiently dull to avoid puncture of inflatable member 56.

Referring now to FIGS. 8A-8E, an illustrative method of using apparatus 10 is provided. Guide catheter 46 is advanced through esophagus E and disposed in a proximal portion of stomach S. Endoscope 50 and delivery catheter 52 then are advanced through the guide catheter, with plurality of anchors 12 disposed surrounding inflatable member 56. Under the visual guidance provided by endoscope 50, delivery catheter 52 is positioned within stomach S. Thereafter, inflation fluid, e.g., air or water, is introduced through lumen 54 of catheter 52 into inflatable member 56 to expand the inflatable member until plurality of anchors 12 forcefully contact lumen wall W of stomach S. The pressure from the expansion of inflatable member 56 causes barbs 20 to penetrate into lumen wall W. Since distal ends 24 of barbs 20 (see FIG. 4) are configured to resist disengagement of the barbs from lumen wall W, and anchors 12 are adhered to inflatable member 56 with a weak adhesive, anchors 12 disengage from inflatable member 56 without pulling barbs 20 from lumen wall W when the inflatable member is deflated. Thereafter, delivery catheter 52 and deflated inflatable member 56 are removed from the patient through guide catheter 46.

To tighten drawstring 14, and thereby cause a localized reduction in the cross-sectional area of stomach S, catheter 58, having end effector 60, is provided for disposal within stomach S through guide catheter 46. End effector 60 comprises a mallet/anvil assembly that can grasp fastener 16 by manipulating an actuator (not shown) disposed on a proximal end of catheter 58. After end effector 60 is engaged to fastener 16, concurrent application of a distal force to catheter 58 and a proximal force to the ends of drawstring 14 distally urges fastener 16 along drawstring 14. Continual advancement of fastener 16 tightens drawstring 14, drawing each anchor 12 closer to adjacent anchors. Since anchors 12 are engaged to lumen wall W, this causes a localized reduction in the cross-sectional area of stomach S and forms stoma 11, as shown in FIG. 8E.

Once sufficient tension has been applied to drawstring 14 to obtain a lumen through stoma 11 of desired cross-sectional area, end effector 60 may be disengaged from fastener 16 and proximally retracted from guide catheter 46. To reduce drawstring 14 to an appropriate length within stomach S, catheter 62 having end effector 64 comprising a pair of scissors is advanced through guide catheter 46. Once drawstring 14 has been cut, guide catheter 46 is removed from the patient along with catheter 62, endoscope 50 and the severed portion of drawstring 14 that is disposed through guide catheter 46.

Of course, it will be evident that anchors 12 may be delivered to stomach S without drawstring 14 having been pre-threaded through fixture points 15 prior to adhesion of the anchors to inflatable member 56. In such a case, after anchors 12 have been engaged to lumen wall W, a catheter having an appropriate end effector may be inserted through guide catheter 46 to thread drawstring 14 through fixture points 15.

FIG. 9 describes an alternative delivery catheter for engagement of anchors 12 to lumen wall W. Rather than having an inflatable member, delivery catheter 64 has end effector 66, which comprises a mallet/anvil assembly. More specifically, end effector 66 includes two pinchers 68 rotatably mounted to the distal end of catheter body 70. Pinchers 68 are coupled to springs 72, which bias pinchers 68 closed in its equilibrium state. To grasp an object with end effector 66, a proximal force may be applied to wires 74, which are attached to pinchers 68. A proximal force of sufficient magnitude overcomes the spring forces applied by springs 72, opening pinchers 68 for engagement with an object therebetween. It will be apparent to one of ordinary skill in the art that minor modifications may be made to the attachment points of springs 72 and wires 74 to bias pinchers 68 open.

In operation, anchor 12 is placed against an inner surface of lumen wall W. Pinchers 68 are actuated to grasp anchor 12 and lumen wall W so that they fold into the space between pinchers 68. Pressure applied by pinchers 68 penetrates barbs 20 into lumen wall W, thereby engaging anchor 12 thereto.

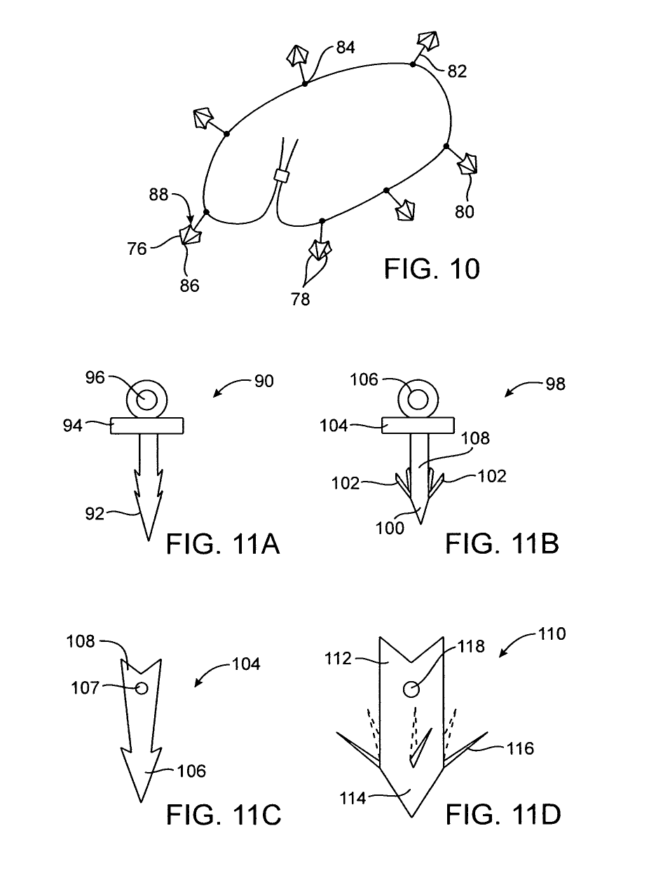

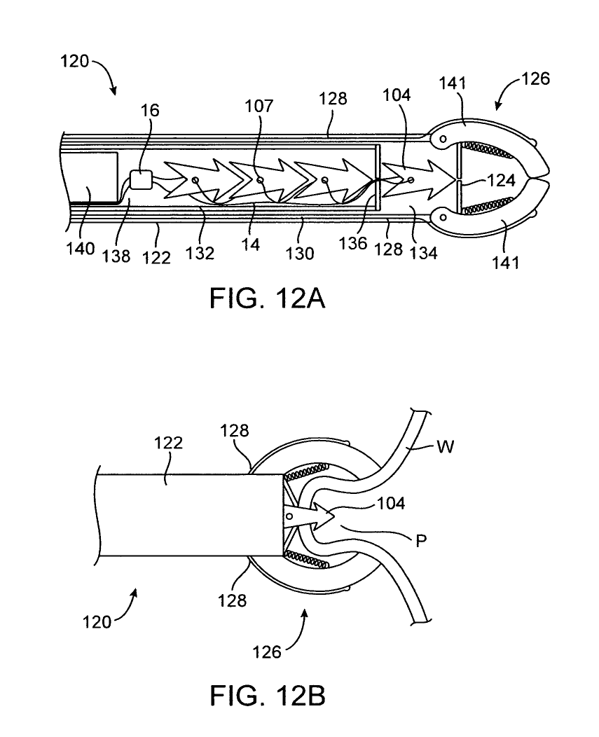

Referring now to FIG. 10, an alternative embodiment of the plurality of anchors of the present invention is described. Each anchor 76 incorporates multiplicity of struts 78 that optionally are covered by membrane 80, shank 82 preferably having a length approximately equal to or slightly less than the thickness of lumen wall W, and fixture point 84, e.g., an eyelet, through which drawstring 14 may be threaded. Struts 78 are re-configurable from a reduced delivery profile, in which struts 78 closely approximate shank 82, to an expanded profile shown in FIG. 10, in which struts 78 form a conical shape. The conical shape provides a sharp tip at distal end 86 of anchor 76 to facilitate penetration of lumen wall W. Moreover, the conical shape formed by struts 78 provides wide base 88 at the proximal end of the struts to decrease the risk that anchor 76 may retract through lumen wall W when drawstring 14 is tensioned. Struts 78 may completely penetrate through lumen wall W to deploy distal to the lumen wall, as shown in FIG. 12B, or may penetrate partially through lumen wall W to deploy within the lumen wall.

Alternative embodiments of anchors 76 are provided in FIGS. 11A-11D. In FIG. 11A, anchor 90 is shown having barbed distal end 92, optional stop 94, and fixture point 96, e.g., an eyelet. Optional stop 94 is disposed proximal to barbed distal end 92 to decrease the likelihood that anchor 90 may penetrate too far into lumen wall W. It will be apparent that, while FIG. 11A illustrates distal end 92 having two barbs, more or less barbs also may be provided.

In FIG. 11B, anchor 98 has sharp distal end 100, pivoting struts 102, stop 104, and fixation point 106. When disposed in a reduced delivery profile to penetrate lumen wall W, pivoting struts 102 may be disposed flush against shank 108 of anchor 98, as shown by the dashed lines. After struts 102 are inserted past lumen wall W, pivoting struts 102 assume an expanded profile in which the struts extend outwardly so that proximal ends of the struts abut against an outer surface of the lumen wall when a proximally directed force is applied to the anchor. This decreases the risk that anchor 98 may retract through lumen wall W when drawstring 14 is tensioned.

FIGS. 11C and 11D describe alternative embodiments to anchors 90 and 98, respectively. Anchor 104 of FIG. 1C includes barbed distal end 106 similar to that of anchor 90, fixture point 107, and indented proximal end 108 that facilitates delivery of multiple anchors. Specifically, multiple anchors 104 may be loaded into a delivery catheter such that distal end 106 abuts the indentation of proximal end 108 of an adjacent anchor 104, as will be described in greater detail hereinbelow with respect to FIGS. 12A and 12B. Likewise, anchor 110 of FIG. 11D also incorporates indented proximal end 112 in addition to sharp distal end 114, pivoting struts 116 that are expandable from a reduced delivery profile to an expanded profile, and fixture point 118.

Referring now to FIGS. 12A and 12B, a delivery catheter for delivering the anchors of FIGS. 10 and 11A-11D is described. Delivery catheter 120 includes outer catheter 122 having outer distal end 124, and end effector 126 that is rotatably coupled to outer distal end 124 and that is similar to end effector 66 of FIG. 9. Wires 128 that permit a clinician to control end effector 126 from an actuator (not shown) disposed on a proximal end of delivery catheter 120 are disposed through annular lumen 130 of outer catheter 122. Additional wires (not shown) that enhance steerability of catheter 122 also may be included.

Delivery catheter 120 further comprises inner catheter 132 slidably disposed within central lumen 134 of outer catheter 122. Inner catheter 132 has inner distal end 136 and inner lumen 138, within which plurality of anchors 104 are disposed for delivery to lumen wall W. As discussed hereinabove, drawstring 14 preferably is pre-threaded through fixture points 107 of anchors 104, and fastener 16 preferably is engaged to drawstring 14 prior to disposal of anchors 104 within inner lumen 138 to facilitate delivery of anchors 104. Also disposed within inner lumen 138 proximal to anchors 104 and fastener 16 is push rod 140.

In operation, delivery catheter 120 is advanced through one of the lumens of guide catheter 46 to stomach S. Under the visual guidance of endoscope 50, delivery catheter 120 is maneuvered to dispose end effector 126 adjacent lumen wall W. Wires 128 then are actuated to open pinchers 141 of end effector 126 to grasp the lumen wall therebetween, forming a fold of lumen wall W that defines pocket P distal thereto and that closely approximates outer distal end 124 of outer catheter 122. Thereafter, push rod 140 is distally advanced to urge one anchor 104 through inner distal end 136 into central lumen 134 of outer catheter 122. To determine when one anchor has been ejected from inner catheter 132, indicia (not shown) on a proximal end of delivery catheter 120 may be provided. After one anchor 104 is disposed within central lumen 134 between inner and outer distal ends 136 and 124, inner catheter 132 is advanced distally to urge anchor 104 through outer distal end 124 and into lumen wall W. Further distal advancement of inner catheter 132 relative to outer catheter 122 causes anchor 104 to penetrate through lumen wall W and into pocket P as shown in FIG. 12B. Advantageously, pocket P shields organs, vessel, and/or nerves in the vicinity of the stomach from advancement of anchor 104, thereby decreasing the risk that the anchor may inadvertently damage surrounding tissue during delivery of the anchor.

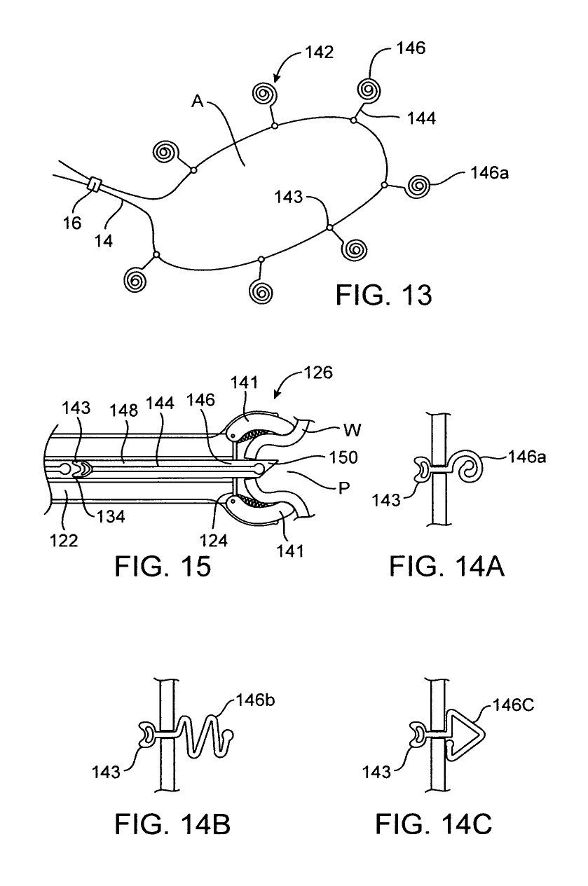

Referring now to FIG. 13, a further alternative embodiment of the plurality of anchors is described. Each anchor 142 comprises fixture point 143 through which drawstring 14 may be threaded, and elongated shaft 144 that may be reconfigured from a reduced delivery profile, as shown in FIG. 15, to an expanded profile. When anchor 142 is disposed in its expanded profile, shaft 144 assumes a coiled shape at distal portion 146 that may be of a spiral configuration (146a in FIGS. 13 and 14A), a zigzag configuration (146b in FIG. 14B), a triangular configuration (146c in FIG. 14C), or combinations thereof. It is contemplated that distal portion 146 also may assume a multitude of other configurations having an expanded profile.

To deliver distal portions 146 of anchors 142 through lumen wall W, anchors 142 are disposed in their reduced delivery profile within catheter 148 (see FIG. 15). Catheter 148 includes sharp distal tip 150 that may penetrate lumen wall W, and a push rod (not shown) that may be distally actuated to urge anchors 142 through distal tip 150. Catheter 148 may be slidably disposed within central lumen 134 of outer catheter 122 of FIGS. 12A and 12B, replacing inner catheter 132. In operation, after pinchers 141 of end effector 126 have grasped a fold of lumen wall W into approximation with distal end 124 of outer catheter 122, catheter 148 is advanced distally through lumen wall W, using sharp distal tip 150 to penetrate therethrough. Thereafter, the push rod distally is advanced through catheter 148 to urge proximal portion 146 of shaft 144 into pocket P. Once proximal portion 146 is advanced past distal tip 150, it assumes its expanded profile. Proximal retraction of catheters 148 and 122 releases the remaining portion of elongated shaft 144 and fixture port 143 therefrom. Contact between expanded proximal portion 146 and a distal surface of lumen wall W prevents anchor 142 from being retracted through lumen wall W back into stomach S.

Referring now to FIG. 16, yet another alternative embodiment of the plurality of anchors of the present invention is described. Each anchor 152 includes shank 154 coupled to fixture point 160 disposed at the proximal end of shank 154, and to distensible, fluid permeable enclosure 156 that is disposed at the distal end of shank 154 and that contains water-swellable gel 158. Water-swellable gel 158 comprises a substance that may be delivered in a solid granular state, and that swells or increases in volume in the presence of water. One example of a water-swellable gel suitable for use with the apparatus and methods of the present invention is a hydrogel, such as polyacrylamide. A number of synthetic and animal-based hydrogels are known in the art. Catheters 122 and 148 of FIG. 15 may be used to deliver anchors 152.

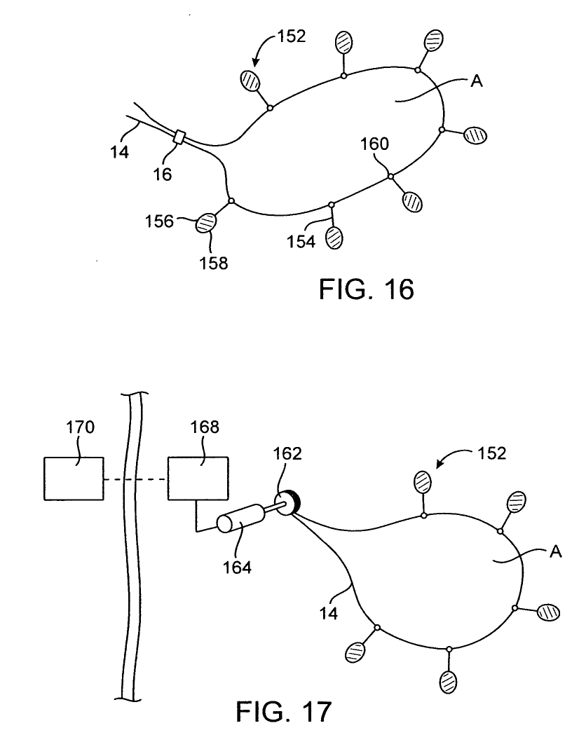

Rather than endoscopically manipulating fastener 16 to adjust the tension in drawstring 14 and thus adjust the localized reduction in the cross-sectional area of the GI lumen, remote adjustment of drawstring 14 may be provided. As depicted in FIG. 17, drawstring 14 is wound around reel 162, which is coupled to motor 164. Motor 164 is energized by a power source disposed within internal control unit 168, which may be subcutaneously implanted within the patient. Internal control unit 168 further comprises an antenna to receive wireless signals generated and transmitted by external control unit 170, and circuitry that electrically couples and controls motor 164, the power source, and the antenna. External control unit 170 includes a user interface, circuitry to generate a wireless signal for receipt by internal control unit 168, and a signal transmitting antenna to transmit the wireless signal. Suitable motors and control units for use with the apparatus and methods of the present invention are described in U.S. Pat. No. 6,210,347 to Forsell, the entirety of which is incorporated herein by reference. Additional telemetric apparatus and methods also are well known in the art.

In use, a clinician inputs commands into external control unit 170, which generates a wireless signal responsive thereto. The wireless signal is transmitted by the transmitting antenna within external control unit 170, and received by the receiving antenna within internal control unit 168, which then energizes motor 164 to turn reel 166. If the command input by the clinician calls for a reduction in cross-sectional area A, motor 164 will actuate reel 166 to wind an appropriate length of drawstring 14 therearound. Conversely, if the command input by the clinician calls for an increase in cross-sectional area A, motor 164 will actuate reel 166 to unwind an appropriate length of drawstring 14 therefrom. In this manner, the localized reduction in the cross-sectional area of stomach S defined by drawstring 14 may be remotely adjusted.

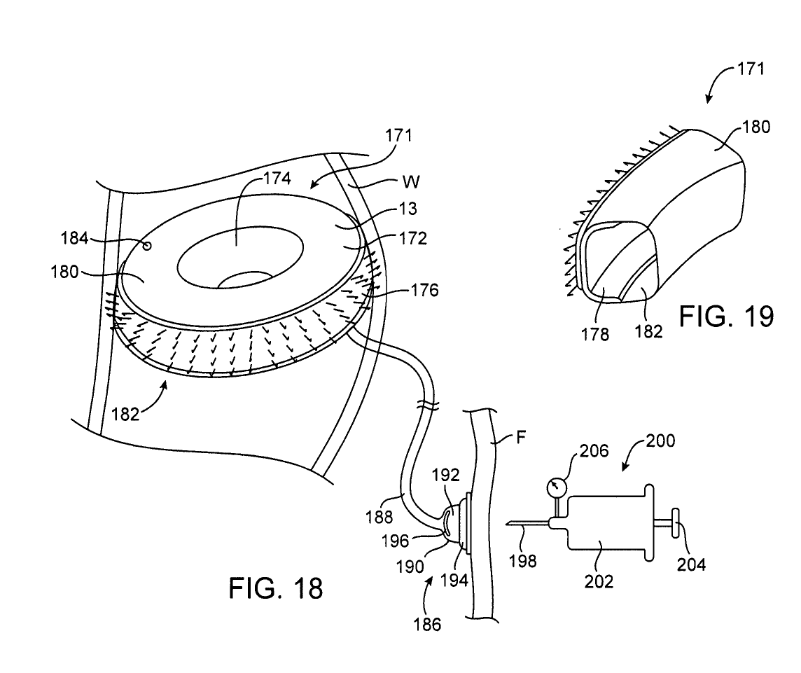

Referring now to FIGS. 18 and 19, an alternative embodiment of apparatus of the present invention is described. Apparatus 171 comprises toroidal balloon 172 and at least one anchor 176 to engage balloon 172 to lumen wall W. Balloon 172 comprises membrane 178, which is fabricated from a non-extensible material, e.g., Dacron. Membrane 178 is disposed to line balloon 172 to constrain proximal, distal and outward radial expansion of balloon 172 so that adjustments to a volume of inflation medium, e.g., air, water or contrast fluid, within the balloon substantially effects only cross-sectional area A of stoma 174.

In contrast to drawstring 14 and the elongated gastric band described in the “Background of the Invention”, the partition of the present embodiment creates a localized reduction in the GI lumen without substantially altering the native shape of the lumen, or, when used in conjunction with a VBG procedure (see FIG. 33), the native shape of the VBG pouch. Balloon 172 creates a partition or reduction in the GI lumen or pouch and defines stoma 174 having a cross-sectional area smaller than the native cross-sectional area of the GI lumen or pouch. To control the rate that food passes through stoma 174 and thus the GI lumen or pouch, only cross-sectional area A of stoma 174 substantially is adjusted, e.g., through inflation and deflation of the balloon. Advantageously, without the need to substantially alter the native shape of the GI lumen or pouch, the risk of causing trauma is reduced.

To inflate balloon 172 and thereby adjust or regulate cross-sectional area A of stoma 174, inflation medium may be endoscopically injected through re-sealable port 184, which is disposed on proximal surface 180 of balloon 172. Re-sealable port 184 is covered by a septum preferably made of silicone, so that the septum will not leak even after repeated punctures. Optionally, re-sealable port 184 may further comprise an endoscopically retrievable tube (not shown) for accessing port 184.

Alternatively, inflation medium, e.g., air, water or contrast fluid, may be introduced through inflation port 186, which is coupled through tube 188 in fluid communication with balloon 172. Tube 188 preferably comprises a fluid impermeable, substantially non-extensible material, i.e., one having very low compliance, so that the tube does not “absorb” volumes of inflation medium that are intended to be infused into or withdrawn from the balloon. Inflation port 186 incorporates body 190 defining chamber 192, re-sealable septum 194 disposed distal to chamber 192, and stop 196 disposed within chamber 192. Septum 194 preferably is made of silicone, so that the septum will not leak even after repeated punctures by needle 198 of source 200 of inflation medium. Stop 196 prevents needle 198 from puncturing body 190 of inflation port 186 during insertion thereof. Inflation port 186 preferably is encapsulated with silicone and includes a plurality of suture holes for anchoring body 190 to subcutaneous fascia F with septum 194 facing outward in vivo. A puncture may be made through lumen wall W in a manner similar to a percutaneous endoscopic gastrotomy to permit delivery of inflation port 186 to subcutaneous fascia F and disposal of tube 188 across the lumen wall.

Source 200 of inflation medium preferably comprises needle 198, body 202 containing inflation medium, and plunger 204 which may be actuated to inject (or withdraw) inflation medium into (or from) inflation port 186 through needle 198. Needle 198 preferably is non-coring, i.e., the needle will not bore a piece out of septum 194 when inserted into inflation port 186. Source 200 also may comprise optional pressure gauge or transducer 206 to measure and display the pressure in inflation port 186.

In the embodiment of FIG. 18, anchor 176 comprises a substrate having a multiplicity of barbs similar to those described with reference to FIGS. 1-4. It will be apparent to one of ordinary skill in the art that anchor 176 also may comprise a plurality of substrates each having a multiplicity of barbs. Furthermore, anchor 176 also may include any of the anchors described above with reference to FIGS. 10, 11A-11D, 13, 15A-15C and 16, or a combination thereof.

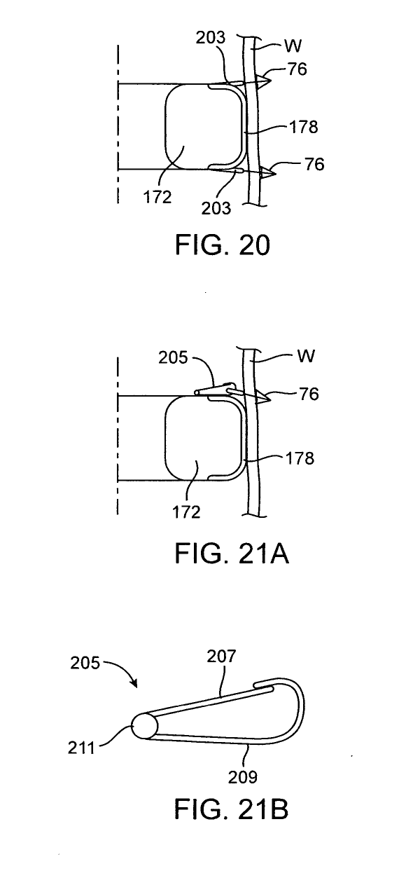

For example, as shown in FIG. 20, balloon 172 may be provided with a plurality of tabs 203 to which anchor 76 of FIG. 10 may be sutured prior to delivery into the GI lumen or after anchors 76 have been embedded within lumen wall W. Tabs 203 may be provided on both proximal and distal surfaces 180 and 182, respectively, so that additional anchors may be coupled to balloon 172 to enhance engagement of balloon 172 with lumen wall W. Furthermore, to counter distally-directed gravitational forces applied by food resting on proximal surface 180 of balloon 172, one or more of anchors 76 may be disposed through lumen wall W in a distally radial direction, as shown in FIG. 20.

Alternatively, as described in FIG. 21A, one or more tabs 203 may be replaced with a plurality of latches 205 to which anchors 76 may be attached. Detailed in FIG. 21B, latch 205 includes first arm 207, second arm 209 having a J-shape, and torsional spring 211 that biases second arm 209 against first arm 207 to prevent anchor 76 from disengaging from the latch. It will be apparent to one of ordinary skill in the art that additional latch configurations also may be provided.

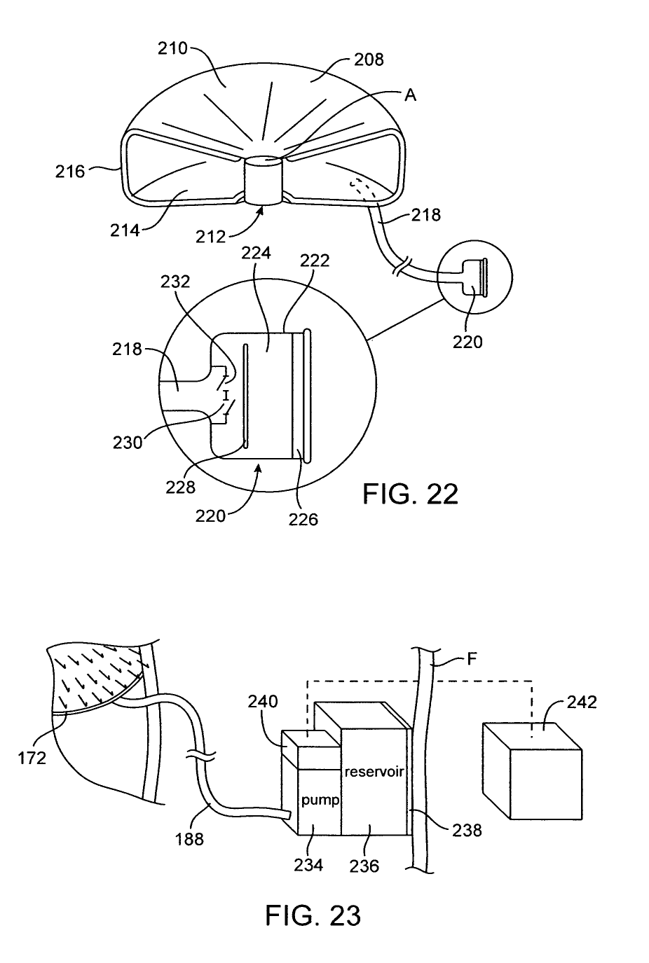

In FIG. 22, an alternative embodiment of balloon 172 and inflation port 186 of FIG. 18 is described. Balloon 208 includes proximal surface 210 having an incline that funnels food deposited thereon into adjustable diameter stoma 212, which couples proximal surface 210 and distal surface 214. Balloon 208 also has membrane 216 disposed to constrain proximal, distal and outward radial expansion of balloon 208. Membrane 216 preferably comprises a non-extensible material, e.g., Dacron or polypropylene.

Coupled in fluid communication with balloon 208 via substantially non-extensible tube 218 is inflation port 220. In addition to having compliant body 222 defining chamber 224, septum 226 preferably made of silicone, and stop 228 to prevent a needle of a source of inflation medium from penetrating body 222, inflation port 220 further incorporates unidirectional inflow valve 230 and unidirectional outflow valve 232, both of which preferably are disposed within chamber 224. Inflow valve 230 permits inflation medium to flow from tube 218 into chamber 224 at a rate slower than the rate that outflow valve 232 permits inflation medium to flow in the reverse direction. Illustratively, this effect may be achieved by restricting the opening of inflow valve 230, as compared with the opening of outflow valve 232.

This permits the present invention to dynamically adjust the diameter of stoma 212 responsive to the pressure of food in the GI lumen proximal to proximal surface 210 of balloon 208 in the following manner: In operation, stoma 212 preferably is completely closed or has a small cross-sectional area A in its equilibrium state, i.e., the state in which food is absent. When food enters the GI lumen proximal to balloon 208 and contacts proximal surface 210, the pressure within the balloon exceeds the pressure within chamber 224. The resultant pressure gradient drives inflation medium from balloon 208 to inflation port 220 through restricted inflow valve 230, thereby increasing cross-sectional area A of stoma 212 by partially deflating balloon 208. Inclined proximal surface 210 and increase in the cross-sectional area of stoma 212 facilitates disposal of accumulated food through stoma 212 into a distal portion of the GI lumen. Preferably, to enhance the feeling of satiety and thereby decrease the amount of food consumed, the rate that cross-sectional area A increases is slower than the rate of food consumption.

After all the accumulated food has emptied into the distal portion of the GI lumen, the resulting removal of pressure from proximal surface 210 of balloon 208 causes a shift in the pressure gradient, in which the pressure in inflation port 220 becomes greater than that in balloon 208. This pressure gradient drives inflation medium from inflation port 220 back into balloon 208 to re-inflate the balloon, causing stoma 212 to resume its equilibrium cross-sectional area. Since outflow valve 232 has a bigger opening than that of inflow valve 230, flow of inflation medium back into balloon 208 occurs at a faster rate than flow of inflation medium into inflation port 220. A reservoir similar to that described hereinbelow with respect to FIG. 23 may be provided to hold inflation medium flowing in and/or out of port 220 during dynamic regulation or adjustment. Advantageously, dynamic adjustment of cross-sectional area A of stoma 212 that can be substantially closed prevents a patient from imbibing a liquid diet to compensate for the decrease in solid foods that he may comfortably consume.

Pursuant to another aspect of the present invention, stoma 174 defined by balloon 172 may be remotely adjusted. As described in FIG. 23, balloon 172 may be coupled in fluid communication via tube 188 to pump 234 and reservoir 236, both of which preferably are anchored to subcutaneous fascia F. Reservoir 236 also may include septum 238 made of silicone so that additional inflation medium may be introduced as needed through fascia F. Electrically coupled to pump 234 is internal control unit 240.

Similar to internal control unit 168 of FIG. 17, internal control unit 240 also includes a power source to energize pump 234, an antenna to receive wireless signals generated and transmitted by external control unit 242, and circuitry that electrically couples and controls pump 234, the power source, and the antenna. External control unit 242 includes a user interface, circuitry to generate a wireless signal for receipt by internal control unit 240, and a signal transmitting antenna to transmit the wireless signal. Commands input into external control unit 242 are transmitted as wireless signals to internal control unit 240, which then actuates pump 234 to drive inflation medium into or out of balloon 172, depending on whether the cross-sectional area of stoma 174 needs to be decreased or increased, respectively. Suitable hardware for use with the apparatus and methods of the present invention are described in aforementioned U.S. Pat. No. 6,210,347 to Forsell. Additional telemetric apparatus and methods also are well known in the art.

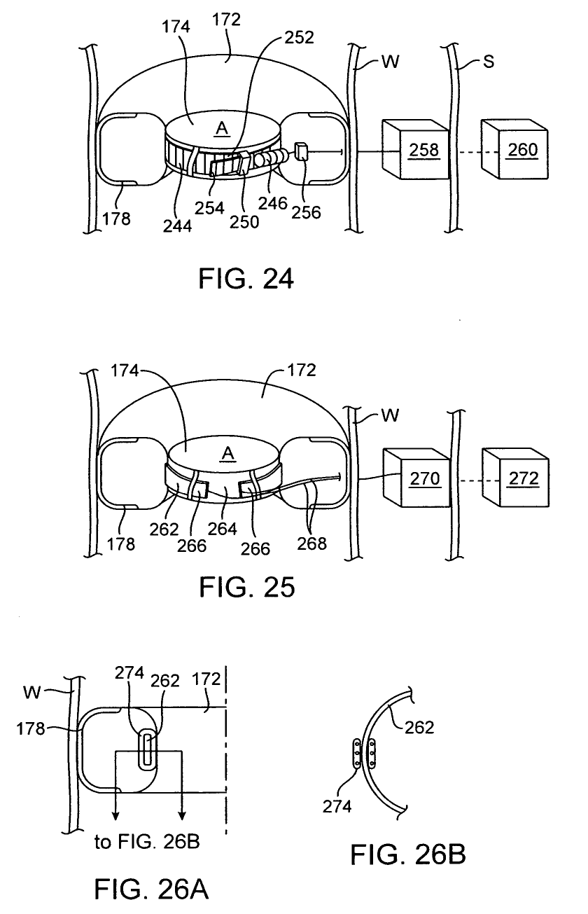

Alternatively, cross-sectional area A of stoma 174 may be adjusted through direct mechanical reduction of the circumference of stoma 174. One example is described in FIG. 24, in which worm gear 244 is disposed around stoma 174 of balloon 172, and engaged to worm 246. To maintain worm gear 244 in a circular shape, buckle 250 is affixed to first end 252 of worm gear 244, and has a slot through which second end 254 may be translatably disposed. Worm 246 is coupled to motor 256, which rotates worm 246 to advance or retract worm gear 244 through buckle 250, thereby decreasing or increasing, respectively, cross-sectional area A of stoma 174. Similar to the apparatus described in reference to FIG. 17, motor 256 is electrically coupled to subcutaneously implanted internal control unit 258, which communicates with external control unit 260 through wireless signals, as described hereinabove.

Referring now to FIG. 25, cross-sectional area A of stoma 174 also may be mechanically adjusted by actuation of thermally-responsive band 262 disposed around stoma 174. Made of a shape memory alloy, e.g., nickel titanium, or an electroactive polymer, band 262 is preformed to transition between an annular configuration having a first diameter and an annular configuration having a second, smaller diameter. To enable the change in diameter, band 262 includes gap 264 located between ends 266 of band 262. Each end 266 is electrically connected via insulated wires 268 to a power source in internal control unit 270, which communicates with external control unit 272 via wireless signals as described hereinabove. When band 262 is energized, it undergoes a phase transition that causes the band to contract from the first diameter into the second, smaller diameter, thereby decreasing the cross-sectional area of stoma 174. To energize and thereby contract band 262, an electrical current may be run through wires 268.

To return band 262 to its non-contracted state, and thereby enlarge cross-sectional area A of stoma 174, a counteracting energizable band (not shown) that is structurally coupled to band 262 may be provided. More specifically, the counteracting band, which is also made of a shape memory material and electrically coupled to internal control unit 270, may be configured to expand from the second diameter to the first diameter when the counteracting band is energized. When the counteracting band expands into the larger diameter, band 262 expands therewith.

Rather than directly energizing band 262, an inductor may be used to heat the band and thereby cause it to contract in diameter. FIGS. 26A and 26B describe band 262 enclosed by at least one toroidal inductor 274. When toroidal inductor 274 is energized, band 262 is inductively heated, causing band 262 to contract in diameter. Exposure to cold water will cause band 262 to return to its non-contracted diameter. Of course, it will be apparent that additional toroidal inductors 274 or other inductor configurations also may be provided.

As previously discussed, illustrative hardware suitable for use with the apparatus and methods of the present invention to remotely adjust cross-sectional area A of stoma 174 are described in U.S. Pat. No. 6,210,347 to Forsell. Additional telemetric apparatus and methods also are well known in the art.

It will be apparent to one of ordinary skill that the remote adjustment mechanisms described hereinabove also may be applied to adjustment of stoma 212 of FIG. 22. Furthermore, the remote adjustment mechanisms described with respect to FIGS. 24-26 also may be used directly with the various types of anchors described in FIGS. 1-4, 10, 11A-11D and 13-15C. For example, drawstring 14 may be replaced by either worm gear 244 or band 262. Worm gear 244 or band 262 may be threaded through fixture points 15 of any of those anchors, and actuated in the manner described above to reduce the cross-sectional area of the stoma defined thereby.

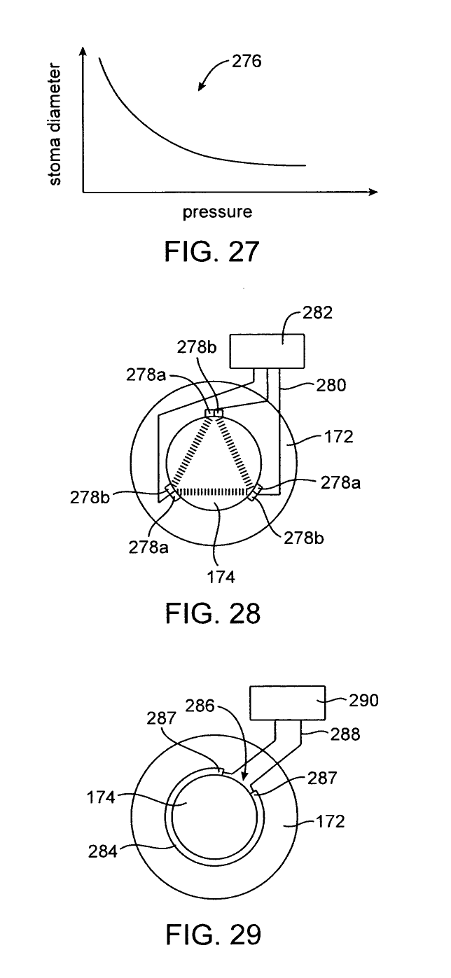

The diameter of stoma 174 of balloon 172 may be determined through numerous techniques. One technique relies on provision of a correlation between the diameter of the stoma and the pressure within either the balloon or the inflation port, if present. An exemplary relationship is shown in graph 276 of FIG. 27, in which the stoma diameter is inversely proportional to the pressure within, e.g., inflation port 186. Pressure within inflation port 186 may be measured by pressure gauge or transducer 206 of FIG. 18. Alternatively, a pressure transducer may be disposed within the balloon, and pressure data obtained thereby may be transmitted from an internal control unit similar to those of FIGS. 23, 24 and 25 to an external control unit for display and/or processing. Graph 276 is provided for illustrative purposes only, and in no way should limit the scope of the invention.

Alternatively, as described in FIG. 28, balloon 172 may be provided with plurality of ultrasound transducers 278 disposed around the circumference of stoma 174 at known and preferably equidistant intervals. Each ultrasound transducer 278 includes first crystal 278a to transmit an ultrasound signal to a second crystal 278b of an adjacent ultrasound transducer that receives the signal. Each crystal is electrically coupled via insulated wires 180 to internal control unit 282, which is coupled through wireless transmission to an external control unit (not shown) that processes data provided by the ultrasound crystals. Internal control unit 282 and the external control unit are similar to the control units described with respect to FIGS. 17 and 23-25, and may be integrated therewith.

In operation, after internal control unit 282 receives a command wirelessly transmitted by the external control unit, the internal control unit instructs first crystals 278a to generate and transmit ultrasound signals to second crystals 278b of adjacent ultrasound transducers. Upon receipt of the signals by the second crystals, the time-of-flight of each transmitted signal is determined, and the linear distances between adjacent transducers are calculated. Geometric triangulation of the calculated distances is used to compute the diameter of the stoma.

Described in FIG. 29, a further alternative embodiment provides balloon 172 with conductive band 284 disposed around stoma 174. Band 284 has a length that adjusts with the diameter of stoma 174 during inflation and deflation of balloon 172, and gap 286 which accommodates adjustment of the length. Band 284 is made of an elastomeric material encapsulating an electrical element, e.g., one or more variable-length resistors, having an aggregate resistance that is proportional to the length thereof. The electrical element incorporated within band 284 is coupled via insulated wires 288 to subcutaneously implanted internal control unit 290, which preferably has an ohmmeter to facilitate measurement of the resistance of band 284. Internal control unit 290 is adapted to transmit wireless signals to an external control unit (not shown). Internal control unit 290 and the external control unit are similar to the control units described with respect to FIGS. 17 and 23-25, and may be integrated therewith. It will be apparent to one of ordinary skill in the art that band 284 also may be made of other materials having similar properties, such as a conductive polymer having length-dependent resistance.

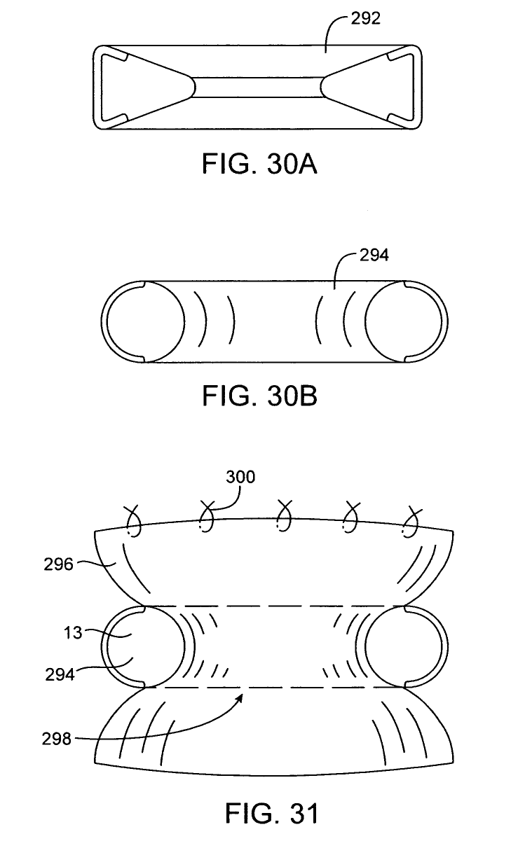

Referring now to FIGS. 30A and 30B, alternative cross-sectional shapes of balloon 172 are provided. FIG. 30A illustrates toroidal balloon 292 having a triangular cross-sectional shape, whereas FIG. 30B describes toroidal balloon 294 having a circular cross-sectional shape. It will be obvious to one of ordinary skill in the art that a variety of other cross-sectional shapes also may be provided without departing from the scope of the invention.

Pursuant to another aspect of the present invention, partition 13 is designed to create a seal with lumen wall W of the GI lumen to prevent food from shunting past the stoma defined by the partition. For example, as shown in FIGS. 18, 24, 25 and 26A, balloon 172 is designed to have an inflated configuration that sealingly engages lumen wall W. To further decrease the risk of food shunting past the stoma defined by the partition, the present invention also may comprise cuff 296 (see FIG. 31) configured for attachment to lumen wall W proximal to partition 13, e.g., toroidal balloon 294, and disposed through stoma 298 to direct food in the GI lumen to pass through the stoma. The length of cuff 296 preferably may be 1 cm to 15 cm long. Cuff 296 may be made from a flexible biocompatible polymer, and engaged to lumen wall W by sutures 300. Exemplary sutures include sutures having shape memory, e.g., made from a super-elastic material such as nickel titanium, or suture wire typically used in surgical procedures. While FIG. 31 shows cuff 296 configured to direct food over balloon 294, cuff 296 also may be adapted to direct food over any of the partitions herein described.

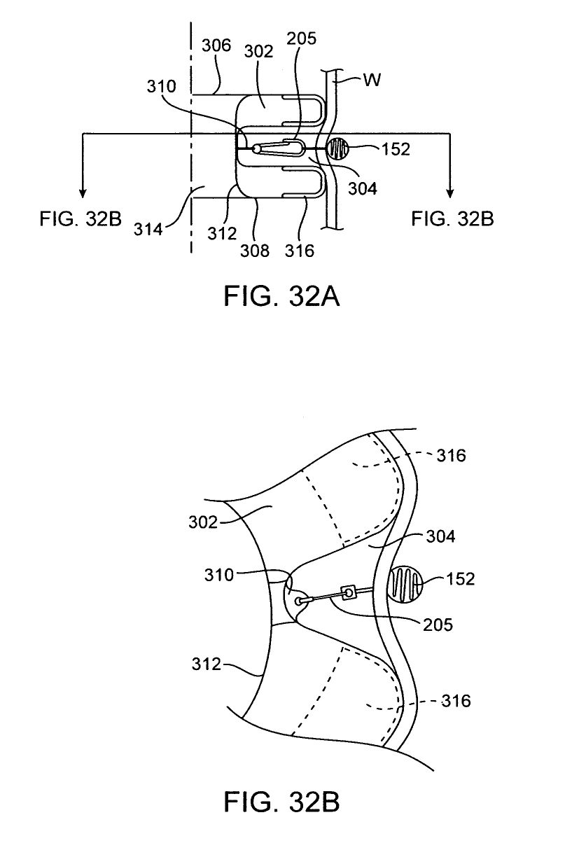

FIGS. 32A and 32B describe yet another alternative embodiment of balloon 172 that further enhances the seal between balloon 172 and lumen wall W. Balloon 302 is similar to balloon 172 except that it also includes plurality of concavities 304 disposed azimuthally around the circumference of the balloon, and preferably mid-depth between proximal surface 306 and distal surface 308. Disposed within each concavity 304 is connector 310 that couples, e.g., anchor 152 of FIG. 16 to balloon 302, either by suturing or use of latch 205 of FIGS. 21A and 21B. Balloon 302 also has inner lateral wall 312, which defines stoma 314, and membrane 316 that constrains expansion of the balloon in the proximal, distal and outer radial directions, thereby directing expansion of balloon 302 substantially in the inner radial direction. Connector 310 is coupled to inner lateral wall 312 of balloon 302 so that anchor 152, disposed through lumen wall W, pulls the lumen wall into conformance with concavity 304 when balloon 302 is inflated and the cross-sectional area of stoma 314 consequently is reduced. Connector 310 may be coupled to inner lumen wall 312 by suture, adhesion, or exposure to heat treatment.

Referring now to FIG. 33, a method of forming a gastric stoma using an alternative embodiment of apparatus of the present invention is described. U.S. Pat. No. 6,540,789 to Silverman et al., which is incorporated herein by reference, describes methods and apparatus for treating obesity by injecting bulking agents into the patient's stomach or pyloric sphincter to increase residence time of food within the stomach and/or to form a stomach restriction. FIG. 33 illustrates the use of bulking agents to form stoma 320 of the present invention at the outlet of Vertical Banded Gastroplasty pouch P within stomach S.

Pouch P preferably is formed endoscopically, as described, for example, in Applicant's co-pending U.S. patent application Ser. No. 10/735,030, filed Dec. 12, 2003, which is incorporated herein by reference in its entirety. Bulking agent stoma 320 is formed at the outlet of pouch P, for example, via catheter 322 having needle 324. Needle 324 injects bulking agent B into the submucosal space of lumen wall W. Optionally, saline or some other space filling fluid may be injected into the interstitial space of lumen wall W prior to injection of bulking agent B, in order to expand the interstitial space for more uniform delivery of the bulking agent.

Injection of bulking agent B forms stoma 320 having lumen L of reduced cross-sectional area, as compared to the cross-sectional area of pouch P. Bulking agent B preferably is injected around the circumference of pouch P to form stoma 320 with a substantially cylindrical profile. Bulking agent B may comprise, for example, a biologic material such as collagen or synthetic material such as polyethylene glycol (PEG). Additional alternative materials will be apparent. Lumen L of stoma 320 preferably has a diameter less than about 1.5 cm, and even more preferably has a diameter less than or equal to about 1 cm.

Regulation of stoma 320 may be achieved by reinserting catheter 322 through a patient's esophagus into pouch P. Needle 324 then may be reinserted within stoma 320 to withdraw or add additional bulking agent B, as needed. Advantageously, the ability to withdraw bulking agent B post-delivery makes formation of stoma 320 reversible. Furthermore, bulking agent B optionally may be fabricated from bioresorbable materials in order to form a temporary stoma 320.

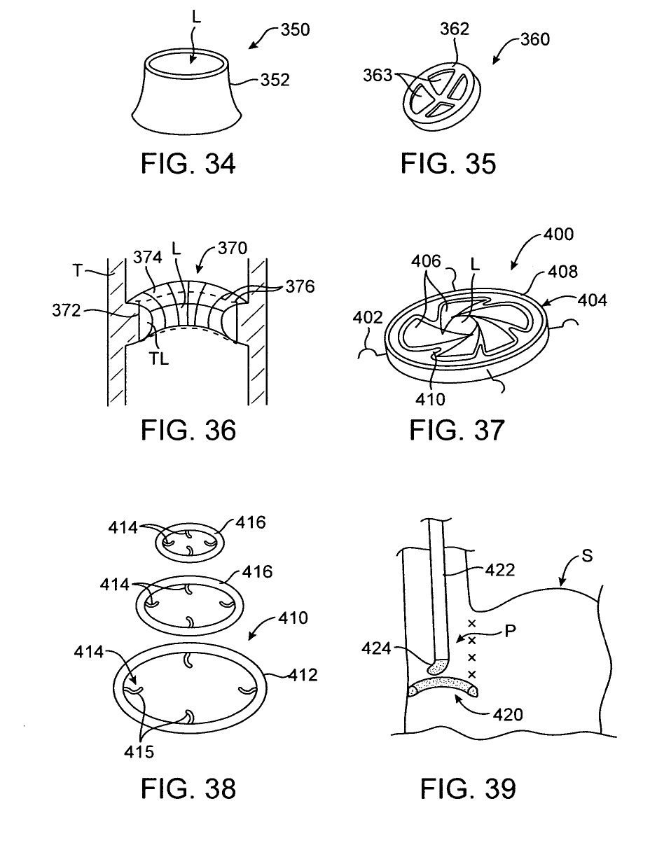

With reference to FIG. 34, another alternative embodiment of the present invention is described. Stoma 350 comprises sewing ring 352. Sewing ring 352 is fabricated from a biocompatible material and is configured to be sutured within a lumen. Ring 352 optionally may comprise, for example, a stent, a braided mesh, a stent graft, etc. Ring 352 comprises lumen L, which preferably has a diameter of less than about 1.5 cm, and even more preferably less than or equal to about 1 cm. Ring 352 may be stitched, e.g. endoscopically, into pouch P of FIG. 33 near the outlet of the pouch to form stoma 350.

In a preferred embodiment, sewing ring 352 is fabricated from a resilient material that provides dynamic adjustment/regulation of stoma 350. When the patient eats an excessive amount of food, a pressure gradient across stoma 350 resiliently expands lumen L of sewing ring 352 to allow passage of the food. Once the pressure gradient has decreased, stress applied to the sewing ring decreases, and stoma 350 resiliently returns to the specified diameter. Stoma 350 preferably is designed such that stoma 350 restricts food passage and expands only when necessary to prevent injury to the patient or perforation of pouch P.

Referring to FIG. 35, another alternative stoma is described. Stoma 360 behaves similarly to a sink drain and comprises sieve 362 having partitions 363. When implanted, for example, at the outlet of pouch P of FIG. 33, partitions 363 hinder passage of food—especially larger pieces of food—through stoma 360. This is expected to increase residence time of food within pouch P, thereby prolonging a sensation of satiety and impeding ingestion of excessive amounts of food. Furthermore, the size and/or configuration of partitions 363 may be chosen such that stoma 360 comprises a specified cross-sectional area, e.g. an area smaller than that of pouch P. As with stoma 350 of FIG. 34, stoma 360 may be fabricated from resilient materials to provide dynamic regulation of the stoma size.

With reference to FIG. 36, a reinforced suture stoma is described. Stoma 370 comprises suture 372, which is sewn through mesh 374 and puckered tissue T to form tissue ledge TL that reduces the cross-section of lumen L through tissue T, thereby forming stoma 370. Stoma 370 optionally also may comprise anchors 376 that secure suture 372 against tissue ledge TL and hold mesh 374 in place. Mesh 374 distributes forces applied to stoma 370 around the circumference of tissue ledge TL, thereby reducing a risk of suture 372 or anchors 376 eroding through the tissue. Mesh 374 may comprise a surgical mesh, per se known, such as a Marlex, Teflon or polypropylene mesh.

FIG. 37 describes an additional embodiment of the present invention comprising adjustable iris stoma 400. Stoma 400 may be endoscopically attached to VBG pouch P of FIG. 33, for example, via anchors, suture, hooks, barbs, etc., such as those described previously. In FIG. 37, stoma 400 illustratively comprises hooks 402 for coupling the stoma to the GI lumen. Stoma 400 further comprises adjustable iris diaphragm valve 404 having a plurality of overlapping elements 406 rotatably coupled to support structure 408.

Iris diaphragm valve 404 is similar to iris diaphragm valves well known in the art, for example, those used to adjust the aperture of a camera lens. Cams 410 of support structure 408 advance overlapping elements 406 into lumen L of stoma 400 upon counterclockwise rotation of support structure 408 relative to the overlapping elements, thereby reducing a cross-sectional area of stoma lumen L. Conversely, relative clockwise rotation of the support structure retracts the overlapping elements from lumen L, thereby increasing the size of the stoma. As will be apparent, the relative counterclockwise/clockwise, advancement/retraction relationship of elements 406 and support structure 408 may be reversed.

When implanted within a patient's stomach, regulation of iris stoma 400 via advancement and/or retraction of elements 406 yields an adjustable mechanical constriction for selectively controlling food passage through stoma 400. Such regulation may be achieved using any of the mechanisms described previously, including, but not limited to, wireless actuation of a motor, injection of a pressurized fluid, use of specialized endoscopic tools, etc. Additional tools will be apparent to those of skill in the art.

With reference now to FIG. 38, yet another alternative, regulable stoma is described. Stoma 410 comprises ring 412, which may be endoscopically sutured, for example, to the outlet of VBG pouch P of FIG. 34, or may be anchored to the pouch by alternative means, such as anchors, barbs, etc. Ring 412 is substantially non-compliant, such that stoma 410 comprises an opening of known dimensions.

Ring 412 preferably comprises element 414, illustratively friction locking lip 415, through which additional smaller rings, e.g. ring 416, may be coupled to ring 412 to reduce the size of stoma 410. Conversely, removing one or more such smaller rings from ring 412 may increase the size of stoma 410. When multiple smaller rings 416 are used to regulate stoma 410, the rings may be nested within one another and interconnected via elements 414 disposed on each nested ring. Advantageously, adjustment of stoma 410 may be achieved after implantation of initial ring 412. Such adjustment or regulation, as well as such initial implantation, preferably is achieved endoscopically.

Referring now to FIG. 39, stoma 420 may be formed at the outlet of pouch P via catheter 422 having energy element 424 disposed at a distal region thereof. Energy element 424 is configured to form stoma 420 by scarring tissue at the outlet of pouch P. Element 424 may comprise, for example, a radiofrequency or ultrasound energy element for scarring the tissue. Such energy preferably is focused to form scar tissue in the muscularis or serosa tissue layers. Reduction in the size of stoma 420 may be achieved by utilizing energy element 424 to form additional scar tissue at the outlet of pouch P. Enlargement may be achieved by excising a portion of the scar tissue, for example, via a cutting element (not shown).

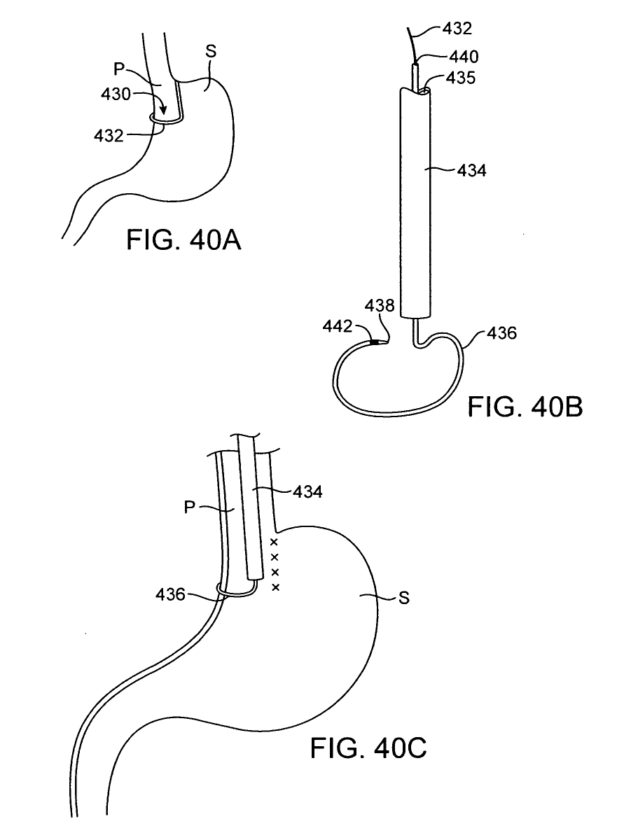

With reference to FIG. 40, stoma 430 of FIG. 40A may be formed with band 432 disposed about the exterior of pouch P and/or stomach S. Band 432 may be placed endoscopically on the exterior of the stomach from within the stomach. As seen in FIG. 40B, stoma 430 may be formed with catheter 434 having lumen 435, as well as pre-shaped needle element 436 that is configured for passage through the lumen. Pre-shaped needle element 436 may be fabricated from a shape-memory material, for example, Nitinol, such that element 436 may assume the profile of lumen 435 while disposed within the lumen, but may assume the curved profile of FIG. 40B when advanced out of the lumen.

Element 436 comprises sharpened distal tip 438, as well as lumen 440 within which band 432 may be disposed. Element 436 preferably further comprises sensor 442, which may comprise a light-emitting diode or a fiber optic that may be visualized from within the stomach to guide the procedure while the needle element is disposed exterior to the stomach. Alternative sensors, such as ultrasonic or magnetic sensors, will be apparent.

In use, catheter 434 may be advanced through a patient's throat into pouch P and/or stomach S, as in FIG. 40C. Element 436 then may be advanced out of lumen 435, such that distal tip 438 penetrates and passes through the wall of stomach S to the exterior of the stomach. Continued advancement of element 436 causes the element to encircle pouch P or stomach S, and reenter the stomach from the exterior to the interior. Encirclement of all or a portion of the stomach optionally may be tracked via sensor 442. After element 436 has encircled the desired portion of the stomach, band 432 may be advanced out of lumen 440, its two ends coupled together in a manner providing stoma 430 with a desired cross-section. Band 432 optionally may comprise one or more of the elements described previously for regulating/adjusting the size of stoma 430.

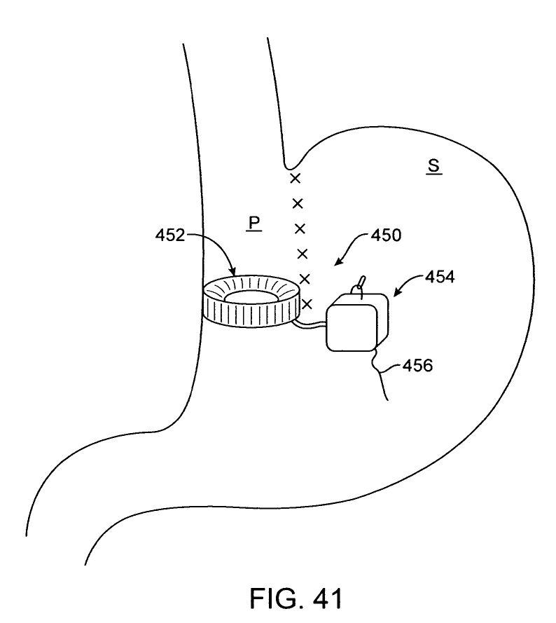

Referring to FIG. 41, a schematic of apparatus 450 comprising stoma 452 formed at the outlet of pouch P, as well as wireless regulation system 454 having antenna 456, is described. Wireless system 454 is coupled to stoma 452, and is configured to transmit data about the stoma to apparatus external to the patient, as well as to receive and act upon instruction from the external apparatus regarding regulation of stoma 452. Advantageously, all elements of apparatus 450 are disposed within stomach S, such that the apparatus may be delivered and deployed completely endoscopically without requiring any surgical incisions. System 454 optionally may be endoscopically sutured to the interior wall of stomach S, and may be encased in an appropriate material to allow long-term implantation. For example, the system may be encased in high-density polyethylene, silicone, Teflon, nylon, titanium, combinations thereof, etc.

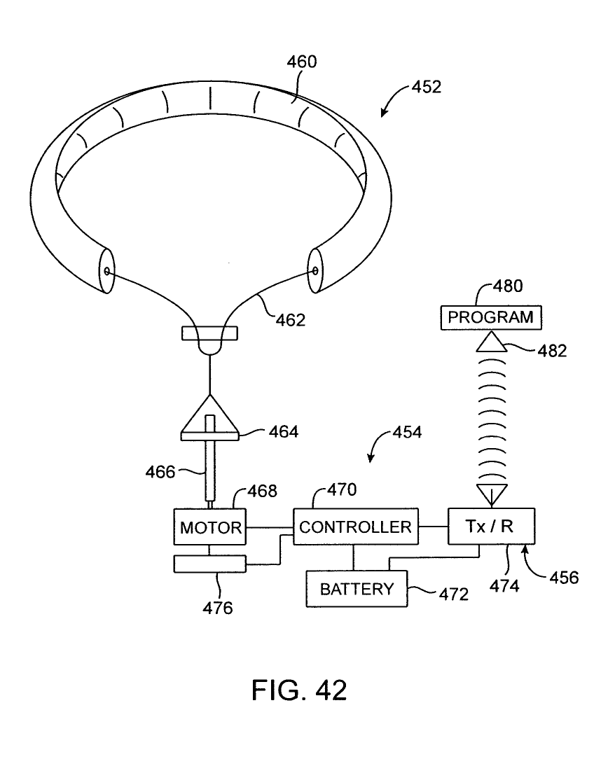

With reference now to FIG. 42, a more detailed illustrative schematic embodiment of apparatus 450 is described. In FIG. 42, stoma 452 comprises internal belt 460 that may be sutured to the wall of pouch P or stomach S. Belt 460 comprises drawstring 462 coupled to nut 464. Drawstring 462 is similar to drawstring 16 described previously. Wireless regulation system 454 comprises screw 466, which is threaded through nut 464 of stoma 452 to adjust the stoma. System 454 further comprises motor 468, controller 470, battery 472 and transmit/receive antenna 474 (which serves as antenna 456 of system 454). System 454 optionally also may comprise encoder 476, e.g. an optical encoder, to provide a feedback control loop that ensures proper regulation of stoma 452. Apparatus 450 further comprises programmer 480 having transmit/receive antenna 482, which is disposed external to the patient and communicates with system 454 via antenna 474.

Stoma 452 may be regulated via system 454 and programmer 480. Encoder 476 and/or controller 470 transmit data regarding stoma 452 to programmer 480 via antenna 474. Programmer 480 receives the data via antenna 482. A medical practitioner then reviews the data and determines appropriate adjustment or regulation parameters for stoma 452, e.g. an increase or reduction in the size of the stoma. The practitioner programs the regulation parameters into programmer 480, which transmits the parameters back to system 454. Transmission of data between controller 470 and programmer 480, and vice versa, may be conducted at a radio bandwidth, via ultrasound, etc.

Controller 470 actuates motor 468 to turn screw 466, thereby advancing or retracting nut 464 to shorten or lengthen, respectively, the portion of drawstring 462 forming stoma 452. This serves to alter the size of stoma 452 as specified by the regulation parameters. After the specified regulation has been achieved, controller 470 stops motor 468. Optional encoder 476 provides feedback to controller 470 that ensures proper regulation has been achieved. If a discrepancy is noted between the parameters input by the medical practitioner and the actual regulation achieved, controller 470 may re-actuate motor 468, as needed, in a control loop feedback cycle.

Power for system 454 is provided by battery 472. Battery 472 preferably comprises adequate energy capacity to facilitate repeated adjustment of stoma 452, for example, at least 50 adjustments, and even more preferably at least 100 adjustments. Additionally or alternatively, battery 472 may be rechargeable. For example, battery 472 may comprise an inductive coil (not shown) for wirelessly recharging the battery. Rechargeable embodiments of battery 472 allow substantially limitless adjustment of stoma 452. Battery 472 preferably comprises a Lithium Ion (“Li-Ion”) battery; additional embodiments, such as Nickel Cadmium (“Ni-Cad”), will be apparent.

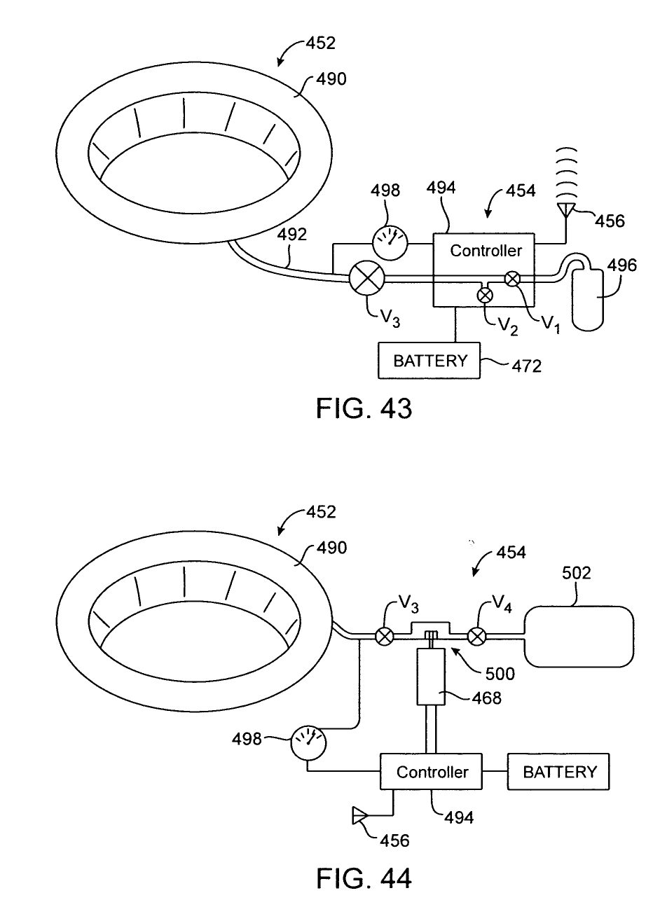

With reference to FIG. 43, an alternative schematic embodiment of apparatus 450 is described. In FIG. 43, stoma 452 comprises inflatable bladder 490, which is similar to balloon 172 of FIG. 18. Bladder 490 is connected via tube 492 to system 454, which comprises controller 494; cartridge 496 containing a pressurized fluid, such as CO₂; pressure valves V1, V2 and V3; and optional pressure gauge 498. Cartridge 496 preferably comprises sufficient pressurized fluid to allow multiple adjustments of stoma 452, for example, at least 50 adjustments and even more preferably at least 100 adjustments. System 454 further comprises battery 472 and antenna 456, and may be used wirelessly in conjunction with programmer 480 described previously to regulate stoma 452.

In use, controller 494 communicates with programmer 480 to exchange data regarding stoma 452 and regulation thereof. When programmer 480 instructs controller 494 to increase the size of lumen L through stoma 452, the controller initiates opening of pressure valves V3 and V2 to vent fluid (air, saline, CO₂, etc.) from inflatable bladder 490 into the patient's stomach, thereby at least partially deflating the bladder and increasing the size of lumen L. When sufficient fluid has been vented from the bladder to achieve the regulation parameters input by the medical practitioner, valves V3 and V2 are closed to maintain stoma 452 at the preferred dimensions. Valve V3 serves as a secondary safety valve to ensure proper pressurization is maintained within bladder 490.

When it is desirable to decrease the size of lumen L, controller 494 initiates opening of pressure valves V3 and V1 to allow pressurized fluid within cartridge 496 to flow into, and inflate, bladder 490. After adequate inflation of the bladder, the pressure valves are closed to maintain the inflation. Pressure gauge 498, disposed on the bladder side of valve V3, may be used to confirm adequate regulation of stoma 452. If proper pressurization is not achieved, pressure gauge 498 may feed this information back to controller 494, such that the controller may fine-tune the adjustment via operation of the pressure valves.

Referring now to FIG. 44, an alternative fluid-based embodiment of apparatus 450 is described. In FIG. 44, controller 494 is coupled to motor-driven pump 500 and reservoir 502, which may be elastic. Furthermore, pressure valves V1 and V2 have been replaced with composite pressure valve V4. In use, controller 494 actuates pump 500 and valves V1 and V4 to drive fluid between bladder 490 and reservoir 502, as needed, to regulate stoma 452. As with the previous embodiment, gauge 498 optionally may provide data to controller 494 and yield a feedback loop for accurate regulation of the stoma.

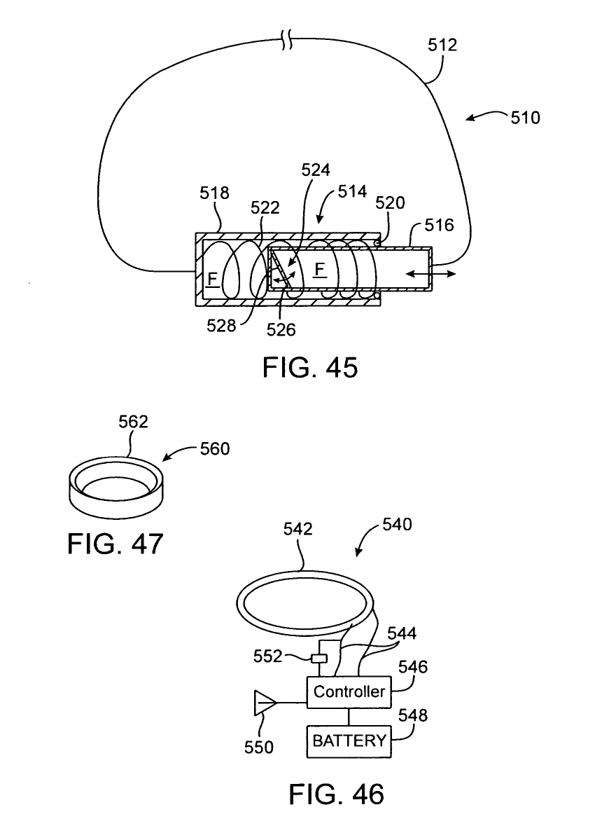

With reference to FIG. 45, a viscoelastic stoma in accordance with the present invention is described. Stoma 510 is configured for dynamic self-regulation in response to a pressure gradient across the stoma, e.g. due to food ingestion. Stoma 510 comprises drawstring 512 coupled to regulation mechanism 514. Regulation mechanism 514 comprises inner piston or cylinder 516 that is slidingly disposed within outer bore or cylinder 518. The inner and outer cylinders comprise a fluid seal via O-ring 520. Tension spring 522, which is connected to outer cylinder 518 at a first end and inner piston 516 at a second end, biases the piston within the bore cylinder. Furthermore, fluid F is disposed within the inner and outer cylinders, such that the cylinders act as a dashpot that dampens relative motion between the two cylinders.

Inner cylinder 516 comprises valve 524 for fluid communication between the inner and outer cylinders. The valve comprises gate 526 that swings open when inner cylinder 516 is slidingly advanced within outer cylinder 518, due to the pressure differential established between the sealed inner and other cylinders. The open gate allows fluid F to freely flow between the two cylinders, thereby providing only a mild damping effect. Conversely, the gate swings shut when the inner cylinder is slidingly retracted from the outer cylinder. Hole 528 in gate 526 allows fluid F to flow more slowly between the two cylinders when the gate is shut, thereby damping such relative motion.

In this manner, regulation mechanism 514 provides for dynamic self-adjustment of stoma 510. Spring 522 biases drawstring 512 to form a small stoma 510. When a significant pressure differential adequate to overcome the spring constant of spring 522 and the viscosity of fluid F is applied across stoma 510, for example, due to ingestion of a substantial quantity of food, inner cylinder 516 is retracted from outer cylinder 518, which expands stoma 510 to relieve the pressure gradient across the stoma and allow food to pass. Closed gate 526 hinders passage of fluid F from the inner cylinder to the outer cylinder, which yields slow expansion of stoma 510.

Conversely, after the pressure differential across the stoma has been reduced, inner cylinder 516 is again advanced within outer cylinder 518 due to tension stored in stretched spring 522. Gate 526 swings open during such relative motion to facilitate easy passage of fluid F from the outer cylinder to the inner cylinder, which yields more rapid contraction of stoma 510. Thus, stoma 510 is dynamically regulated in a manner allowing for slow expansion and rapid reduction. By reducing the rate of expansion relative to reduction, it is expected that enhanced weight loss may be achieved. However, it should be understood that a more linear elastic dynamic regulation mechanism alternatively may be provided.

Referring now to FIG. 46, yet another stoma in accordance with the present invention is provided. Stoma 540 comprises ring 542 formed from an Electroactive Polymer (“EAP”). When subjected to an electrical current, EAP ring 542 contracts. When the electrical current is removed, the ring returns to static diameter. In this manner, ring 542 may be used to provide stoma 540 with a specified diameter. Ring 542 may be coupled via electrical leads 544 to controller 546, battery pack 548, antenna 550 and optional feedback sensor 552. Regulation of ring 542 may be achieved wirelessly via electrical currents supplied to the ring by battery pack 548 in response to commands from controller 546, which in turn are in response to regulation parameters received from a medical practitioner, e.g. via programmer 480 discussed previously.

With reference to FIG. 47, dynamically adjustable stoma 560 is described. Stoma 560 comprises foam ring 562 that compresses when subjected to a stress. Once the stress is removed, the foam ring returns to its original dimensions. Thus, the size of the stoma may dynamically adjust upon application of pressure, for example, when a patient eats a large meal, as well as upon removal of that pressure. Material of fabrication for the foam ring 562 may be specified to control a ratio of stress to strain exhibited by the ring, thereby controlling a degree of alteration upon exposure to a given internal pressure. Furthermore, ring 562 may be fabricated from a memory foam to decrease a rate of expansion and contraction.

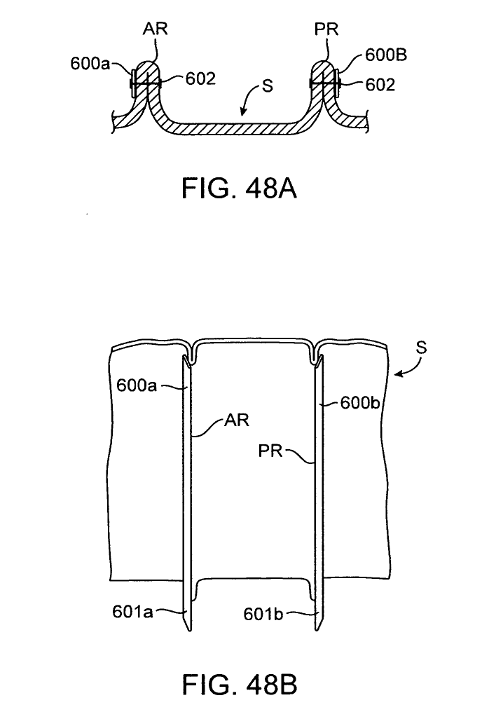

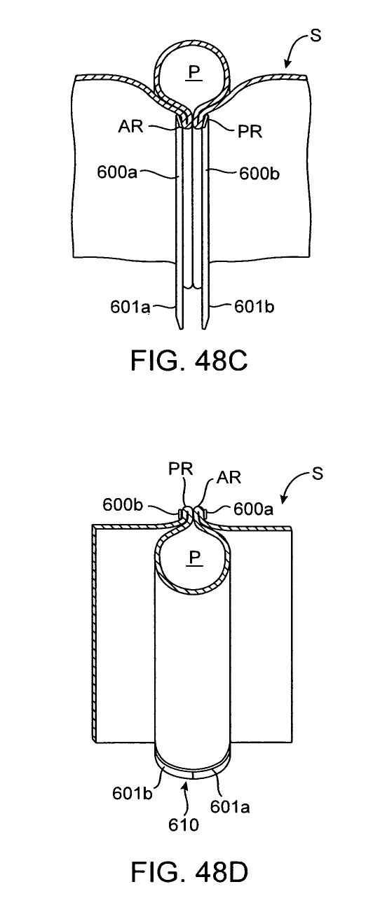

Referring now to FIG. 48, a method of forming a mesh stoma is described. In FIGS. 48A and 48B, mesh strip 600a has been placed on the anterior of stomach S with suture anchors 602 to form anterior plication ridge AR, while strip 600b has been placed on the posterior of the stomach with the suture anchors to form posterior plication ridge PR. As seen in FIG. 48C, the anterior and posterior ridges may be approximated to form pouch P below the gastroesophageal junction. Strips 600 may be placed and maintained, and the ridges may be approximated, using, for example, the system of tools described in Applicant's co-pending U.S. patent application Ser. No. 10/735,030, filed Dec. 12, 2003, which is incorporated herein by reference in its entirety.

Strips 600 comprise trailing edges 601a and 601b, respectively, that are not attached to pouch P. As seen in FIG. 48D, these edges may be grasped, e.g. with an endoscopic grasper, and connected, sutured or otherwise tied off at the outlet of pouch P to form stoma 610 of specified diameter. Stoma 610 may be sutured to pouch P or may hang below the pouch. The stoma reduces the outlet surface area of the pouch, thereby regulating food passage through pouch P.

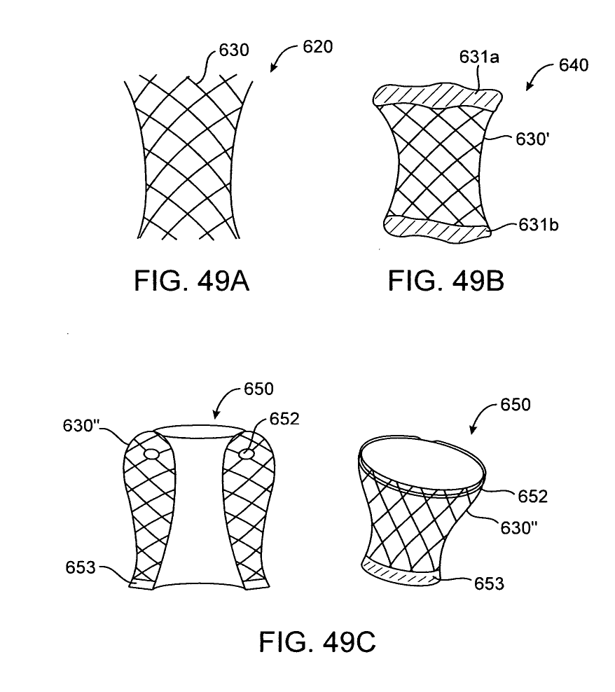

With reference to FIG. 49, various stoma embodiments are described comprising surgical mesh formed into a tube. The tubes may be implanted at the outlet of pouch P to provide a stoma. As will be apparent, as an alternative to surgical mesh, the tube may be fabricated from a braided material, such as a metallic or polymer braid.

In FIG. 49A, stoma 620 comprises mesh or braided tube 630. The diameter of the tube optionally may be dynamically adjusted via pressure imposed by food passing through the stoma. Alternatively, the tube may be sutured or otherwise coupled to tissue along substantially its entire length. Preferably, the tube has a maximum cross-sectional diameter of less than or equal to about 2 cm, and even more preferably has a maximum diameter of about 1 cm. In FIG. 49B, tube 630′ of stoma 640 comprises overmolded or dipped ends 631a and 631b. The ends may be used to couple stoma 640 to pouch P, or to limit dynamic expansion of the stoma.

In FIG. 49C, stoma 650 is shown in both cross-section and side view. The stoma comprises sealing ring 652, e.g. an O-ring, coupled to mesh tube 630″. The mesh or braid of tube 630″ may be wrapped around sealing ring 652 and then fused, sutured or otherwise joined together at seam 653. Stoma 650 may be sutured to pouch P to provide a non-adjustable stoma of specified dimensions. Alternatively, the sealing ring may provide a maximum stoma size, and tube 630″ may dynamically adjust the stoma up to the maximum size. As yet another alternative, tube 630″ may be coupled to the pouch, and the sealing ring may hang therefrom as a non-adjustable stoma.

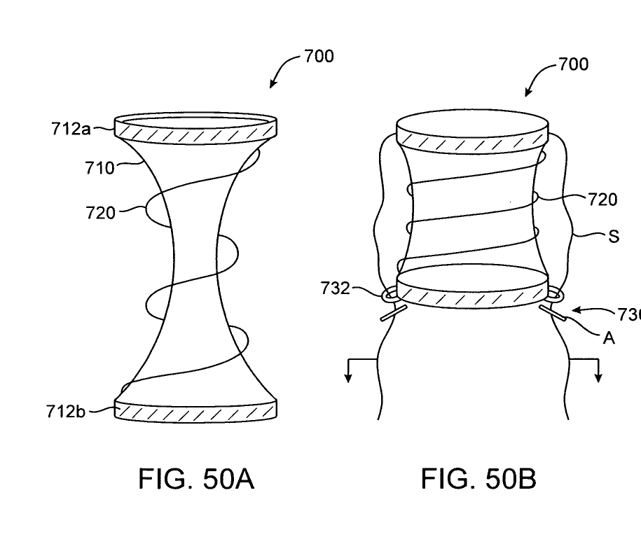

Referring to FIG. 50, an alternative mesh or braid stoma is described. In FIG. 50A, stoma 700 comprises mesh/braid tube 710 having collars 712a and 712b, and compression spring 720 disposed between the collars. Collars 712 provide a maximum diameter for stoma 700, while spring 720 tends to neck down the portion of tube 710 disposed between the collars, thereby providing a minimum diameter. Pressure imposed by food passing through stoma 700 may dynamically regulate the minimum diameter of the stoma up to the maximum diameter imposed by collars 712.

As seen in FIG. 50B, stoma 700 may be regulated actively by providing optional regulator 730 that may compress spring 720 to alleviate the necking of mesh tube 710 caused by the spring, thereby recalibrating the minimum diameter of stoma 700. Preferably, such regulation of stoma 700 may be performed multiple times, as desired, to specify the stoma's minimum diameter. Regulator 730 may, for example, comprise one or more adjustable anchors A coupled to collar 712a via suture S passing through one or more eyelets 732 disposed at collar 712b. Adjustable anchor assemblies are described in Applicant's co-pending U.S. patent application Ser. No. 10/735,030, which is incorporated herein by reference.

While preferred illustrative embodiments of the invention are described above, it will be apparent to one skilled in the art that various changes and modifications may be made therein without departing from the invention. For example, while some embodiments of the present invention have been described as useful for reducing an entire cross-section of the stomach and others have been described as useful for reducing a VBG pouch, it should be understood that all embodiments may be used in either application—as well as further alternative applications—by altering the size of the embodiment. Furthermore, while regulation mechanisms for adjusting embodiments of the present invention have been described in conjunction with specific embodiments, it should be understood that such regulation elements may be modified for use with alternative embodiments of the present invention. Furtherstill, additional embodiments of the present invention, as well as additional regulation mechanisms—be they non-adjustable, dynamically adjustable or actively adjustable—for use with embodiments of the present invention, will be apparent to those of skill in the art in view of this disclosure and are included in the present invention. The appended claims are intended to cover all such changes and modifications that fall within the true spirit and scope of the invention.

1. A flow restriction apparatus for placement within a hollow body organ, comprising:
a plurality of anchors slidingly inter-connected via a drawstring,
wherein the plurality of anchors is adapted to adhere to an interior tissue wall within a hollow body organ, and
wherein each of the plurality of anchors is further adapted to draw towards an adjacent anchor upon tensioning of the partition such that the hollow body organ is restricted.

2. The apparatus of claim 1 further comprising a motor operably connected to the drawstring and adapted to tension the partition relative to the plurality of anchors.

3. The apparatus of claim 2 further comprising a reel about which the drawstring is wound and which is coupled to the motor.

4. The apparatus of claim 2 further comprising a power source in electrical communication with the motor.

5. The apparatus of claim 1 wherein each anchor comprises a substrate and a plurality of barbs adapted to adhere to the interior tissue wall, the plurality of barbs extending from a surface of the substrate.

6. The apparatus of claim 5 wherein the substrate comprises a flexible sheet of biocompatible material.

7. The apparatus of claim 1 wherein each anchor comprises a fixture point thereon or therein through which the partition is slidably disposed.

8. The apparatus of claim 7 wherein the fixture point comprises an eyelet through which the partition is threaded.

9. The apparatus of claim 1 further comprising a fastener slidably disposed along the drawstring.

10. The apparatus of claim 9 wherein the fastener is adapted to slide uni-directionally along the partition.

11. The apparatus of claim 1 further comprising a cuff adjacently positioned relative to the plurality of anchors and configured to engage the interior tissue wall and adapted to direct food to pass therethrough.

12. The apparatus of claim 1 wherein the plurality of anchors comprise a sieve-like configuration having partitions adapted to hinder the passage of food therethrough.

13. The apparatus of claim 1 wherein the plurality of anchors comprise an adjustable iris diaphragm valve having a plurality of overlapping elements rotatably coupled thereto.

14. A flow restriction system for distributing a force applied to a stoma within a hollow body organ, comprising:
a biocompatible mesh adapted to be formed about a stoma formed from tissue within the hollow body organ, the mesh being further adapted to distribute a force from the tissue surrounding the stoma over the mesh; and
a plurality of tissue anchors for adhering the mesh to the tissue surrounding the stoma.

15. The system of claim 14 wherein the mesh comprises a strip for placement against the tissue surrounding the stoma.

16. The system of claim 15 wherein the mesh strip has a length sufficient to extend along a length of a tissue ridge extending proximally of the stoma within the hollow body organ.

17. The system of claim 16 further comprising a second biocompatible mesh strip having a length sufficient to extend along a length of a second tissue ridge extending proximally of the stoma adjacent to the tissue ridge.

18. The system of claim 14 wherein the mesh has a tubular shape adapted for placement through the stoma.

19. The system of claim 18 wherein the tubular-shaped mesh is adapted to dynamically adjust its diameter when food is passed through the stoma.

20. The system of claim 18 wherein the tubular-shaped mesh comprises one or more collars adapted to limit the dynamic adjustment of the diameter.

21. The system of claim 18 further comprising a spring disposed over the mesh for limiting the dynamic adjustment of the diameter.

22. The system of claim 14 wherein the tissue anchors each comprise discrete anchors interconnected via a length of suture passing through the tissue surrounding the stoma.

23. A method of restricting flow through a stoma within a hollow body organ, comprising:
advancing a biocompatible mesh endoluminally into the hollow body organ;
forming the mesh onto tissue surrounding a stoma formed from tissue within the hollow body organ; and
securing the mesh onto the tissue.

24. The method of claim 23 wherein advancing a biocompatible mesh comprises advancing the mesh transesophageally into a stomach.

25. The method of claim 23 wherein forming the mesh onto tissue comprises positioning the mesh over the tissue surrounding the stoma.

26. The method of claim 23 wherein forming the mesh onto tissue comprises placing a tubularly-shaped mesh through the stoma.

27. The method of claim 26 further comprising dynamically adjusting a diameter of the tubularly-shaped mesh when food is passed therethrough.

28. The method of claim 27 further comprising limiting the dynamic adjustment of the diameter via one or more collars formed over the mesh.

29. The method of claim 27 further comprises limiting the dynamic adjustment of the diameter via a spring disposed over the mesh.

30. The method of claim 23 wherein forming the mesh onto tissue comprises positioning the mesh onto a length of a tissue ridge extending proximally of the stoma within the hollow body organ.

31. The method of claim 23 further comprising distributing a force experienced by the tissue surrounding the stoma via the mesh.
